(19) United States
(12) Patent Application Publication
(10) Pub. No.: US 2009/0314262 A1
(43) Pub. Date: Dec. 24, 2009

(54) FUEL SUPPLY DEVICE FOR A DIESEL ENGINE AND METHOD FOR OPERATING A FUEL SUPPLY DEVICE FOR A DIESEL ENGINE

(76) Inventor: Alexander Sellentin, Weissenburg (DE)

Correspondence Address: Workman Nydegger;1000 Eagle Gate Tower, 60 East South Temple, Salt Lake City, UT, 84111, US

(21) Appl. No.: 12/091,667

(22) PCT Filed: Sep. 27, 2006
(86) PCT No.: PCT/IB2006/002688

§ 371 Date: Jul. 15, 2008

(30) Foreign Application Priority Data
Nov. 4, 2005 (DE) 10 2005 053 095.8

(51) Int. Cl. F02G 5/00; G05D 11/00

(52) U.S. Cl. 123/557; 137/88

(57) ABSTRACT

A fuel supply device includes a) at least one first tank for diesel fuel, b) at least one second tank for vegetable oil/fat c) at least one third tank for holding a mixture of the diesel fuel and the vegetable oil/fat, d) wherein each tank has at least one fuel outlet, e) a fuel line system including fuel lines and valves, e1) which fuel line system connects the fuel outlets of all the tanks to the fuel inflow of the injection pump, and e2) which fuel line system connects the fuel return of the injection pump to a fuel inlet of the first tank, and to a fuel inlet of the third tank, and f) a control unit for controlling the fuel flow through the fuel line system. Implementations of the present invention further include methods of operating the same.

The invention relates to a fuel supply device for a diesel engine and to a method for operating a fuel supply device for a diesel engine.

It is known that diesel engines can be operated selectively with diesel fuel or with vegetable oil or vegetable fat. The use of vegetable oil or vegetable fat is associated not only with environmental advantages (inter alia CO2 reduction) but also with operational advantages (for example on account of ever-increasing diesel prices) and economic advantages (for example on account of a reduced dependency on the limited raw material of crude oil).

Here, the use of used vegetable oil or used vegetable fat for operating a diesel engine is of particular significance. Said oils and fats would, if not supplied for any suitable use, have to be disposed of in a complex manner. This requires inter alia comprehensive return and collection logistics. It is therefore desirable for used vegetable oil and used vegetable fat to be made use of in the simplest possible manner where it is generated, for example for operating an already-existing diesel engine, for example in a motor vehicle or in a boat. For the user, this reduces or eliminates the disposal costs for their used vegetable oils and fats, and the operating costs for the diesel engine are also reduced (the user requires to buy less diesel) and a contribution is made to the CO2 reduction on account of the use of renewable raw materials (vegetable oil, vegetable fat).

A problem is, however, that many of the already-existing diesel engines cannot simply be operated with vegetable oil or vegetable fat instead of diesel. Vegetable oil has the disadvantage that, on account of its properties, in particular its high viscosity, that is to say its viscidity, it cannot be used when starting a cold diesel engine, and also the cold running of a diesel engine with vegetable oil is not possible in a satisfactory manner. Already-existing diesel engines must therefore be suitable retrofitted for operation with vegetable fuels, and newly-manufactured engines must be prepared correspondingly.

DE 198 23 335 A1 discloses storing, in addition to vegetable fuel which is used only for warm-running operation of the engine, diesel fuel which is then used when the engine is started and during the cold-running phase. At given times, switches are made back and forth between the two fuels. Said solution is referred to below as the two-tank system.

DE 101 40 071 A1 discloses alternatively to heat the vegetable fuel upstream of the injection device to the engine operating temperature, for example 90°, and to thereby obtain a low viscosity (low viscidity) of the vegetable fuel. In this way, it should be possible to operate the diesel engine with vegetable fuel alone, even in the starting phase. Said solution is referred to below as the pre-heating system.

The previously known solutions however do not lead to satisfactory results in permanent operation. For example, soot depositions occur, which make it necessary for valves and seals of the engine to be cleaned regularly. Since this is often not done in practice, the operation with vegetable fuel leads in many cases to engine faults and even engine failure.

The present invention is therefore based on the object of specifying a fuel supply device and a method for operating a fuel supply device by means of which a diesel engine can also be operated with vegetable oil and/or vegetable fat, in particular used vegetable oil and/or used vegetable fat, and by means of which the above-stated disadvantages of the prior art can be at least partially overcome.

Said object is achieved according to the invention with regard to the device by means of a fuel supply device having the features of claim 1 or having the features of claim 12 or of claim 17 or of claim 19, and with regard to the method by means of a method for operating a fuel supply device having the features of claim 26. Advantageous embodiments and refinements are specified in the claims which are dependent on claim 1, claim 12, claim 17, claim 19 and claim 26.

Claim 1 provides a fuel supply device for a diesel engine having at least one injection pump (also: injection system, injection device) which supplies an injection nozzle with fuel and which has a fuel inflow and a fuel return, wherein the fuel supply device comprises

a) at least one first tank for diesel fuel,

b) at least one second tank for vegetable oil and/or vegetable fat, in particular used vegetable oil and/or fat,

c) at least one third tank for holding a mixture of the diesel fuel and the vegetable oil and/or fat,

d) wherein each of the at least three tanks has at least one fuel outlet,

e) a fuel line system which comprises fuel lines and fuel valves,

e1) which fuel line system connects the fuel outlets of all the tanks to the fuel inflow of the injection pump, and

e2) which fuel line system connects the fuel return of the injection pump to a fuel inlet of the first tank and to a fuel inlet of the third tank, and

f) a control unit for controlling the fuel flow through the fuel line system,

g) wherein in a first state of the fuel line system, only diesel fuel from the first tank can be fed to the fuel inflow of the injection pump and diesel fuel from the fuel return of the injection pump can be fed only to the fuel inlet of the first tank,

h) wherein in a second state of the fuel line system, diesel fuel from the first tank and vegetable oil and/or fat from the second tank can be fed, with preceding mixing in the fuel line system, to the fuel inflow of the injection pump and the mixture from the fuel return of the injection pump can be fed only to the fuel inlet of the third tank, and

i) wherein in a third state of the fuel line system, only the mixture of diesel fuel and vegetable oil and/or fat from the third tank can be fed to the fuel inflow of the injection pump and the mixture from the fuel return of the injection pump can be fed only to the fuel inlet of the third tank.

The proposed solution is therefore a three-tank solution. In contrast to the two-tank solution specified in the introduction, an additional tank is provided for a fuel mixture of diesel fuel and vegetable fuel.

A difference in relation to the pre-heating solution described in the introduction is that the improvement in the viscosity properties of the fuel is obtained not by heating alone but rather in particular by generating and using a fuel mixture of diesel fuel and vegetable fuel. The mixture has a suitable viscosity already at temperatures of approximately 60° C. to 70° C., in contrast to 90° C. in the case of the pre-heating system as per the prior art. The risk of fire and the risk of engine damage are therefore considerably lower in the solution according to the invention.

The fuel supply device according to the invention is of completely different construction than the solutions provided in the prior art. The two-tank solution provides only two states. In the first state, the diesel engine is supplied with pure diesel fuel, and in the second state, only with vegetable fuel. In the three-tank solution according to the invention, in contrast, at least three different states of the fuel supply device can be set, which permits operation of the diesel engine with suitable fuel in a manner adapted to the respective situation.

The invention therefore specifies a fuel supply device which makes it possible to operate a diesel engine reliably and permanently even with vegetable oil and/or vegetable fat and to thereby considerably reduce the operating costs of the diesel engine, to at least reduce the disposal costs for used oil and to make a contribution to CO2 reduction.

According to one preferred refinement, it is provided that, in a fourth state of the fuel line system, only diesel fuel from the first tank can be fed to the fuel inflow of the injection pump and diesel fuel and/or remaining mixture residues from the fuel return of the injection pump can be fed only to the fuel inlet of the third tank.

It is advantageous if the fuel line system comprises at least one mixing valve for providing a mixture of diesel fuel from the first tank and vegetable oil and/or fat from the second tank.

It has proven to be particularly expedient if the mixture provided by the mixing valve has a mixing ratio in the range from 7% diesel and 93% vegetable oil and/or fat to 93% diesel and 7% vegetable oil and/or fat, in particular a mixing ratio in the range from 15% diesel and 85% vegetable oil and/or fat to 20% diesel and 80% vegetable oil and/or fat, preferably of approximately 18% diesel and 82% vegetable oil and/or fat.

In one expedient variant, the mixing valve is adjustable, in particularly continuously adjustable, in order to regulate and/or set the mixing ratio. Here, the mixing valve is preferably mechanically and/or electrically adjustable.

In one advantageous refinement of the fuel supply device according to the invention, at least one heating device for heating the fuel is integrated into the fuel line system.

It is expediently provided in one variant that at least one first heating device is provided for heating the vegetable oil and/or fat which is fed from the second tank after it passes out of the second tank, and/or at least one second heating device is provided for heating the fuel upstream of the fuel inlet of the injection pump, and/or at least one third heating device is provided for heating the vegetable oil and/or fat in the second tank.

Some or all of said heating devices can be electrically operable heating devices. It is however also possible for cooling water heat exchangers to be used for heating the fuel. It is however preferable for at least one, in particular a plurality or all of the heating devices to be heat exchangers which transfer heat from the fuel which is returning from the injection pump to the tank, and which has been intensely heated in the injection pump, to the fuel flowing from the tank to the injection pump. In this way, the fuel which is supplied to the injection pump is brought up to the desired increased temperatures, which is extremely important, on account of the viscidity at low temperatures, in particular for the vegetable oil and/or fat but also for the mixture of diesel fuel and vegetable oil and/or fat, since the engine otherwise does not function in a satisfactory manner.

One particularly preferred embodiment of the fuel supply device provides that at least one filter for cleaning the vegetable oil and/or fat and/or the generated mixture is integrated into the fuel line system. Particularly advantageous is the combination of the filter and the first heating device in one component, since in this way, the heat exchanger also directly heats the filter, thereby improving its functionality.

The fuel supply device as claimed in claim 12 (this is preferably one of the fuel supply devices described above), likewise for a diesel engine having at least one injection pump (also: injection system, injection device) which supplies an injection nozzle with fuel and which has a fuel inflow and a fuel return, comprises

a) at least one first tank for diesel fuel,

b) at least one second tank for vegetable oil and/or vegetable fat, in particular used vegetable oil and/or fat,

c) at least one third tank for holding a mixture of the diesel fuel and the vegetable oil and/or fat,

d) wherein each of the at least three tanks has at least one fuel outlet,

e) a fuel line system, which comprises fuel lines and fuel valve, between the tanks and the injection pump,

f) wherein the fuel outlet of the first tank is connected to a first valve, in particular a 3/2 directional control valve,

g) wherein the fuel outlet of the second tank is connected to a second valve, in particular a 2/2 directional control valve,

h) wherein a fuel inlet of the first tank and a fuel inlet of the third tank are connected to a third valve, in particular a 3/2 directional control valve,

i) wherein the first valve is connected to a fourth valve, in particular a 3/2 directional control valve,

j) wherein the first valve and second valve are connected to a mixing valve,

k) wherein the mixing valve is connected to the fourth valve,

l) wherein the fuel outlet of the third tank is connected to the fourth valve,

m) wherein the fourth valve is connected to the fuel inflow of the injection pump,

n) wherein the fuel return of the injection pump is connected to the third valve, and

o) a control unit for controlling the fuel flow through the fuel line system,

p) wherein in a first state of the fuel line system, the first valve is switched into a first position, the second valve is switched into a closed position, the third valve is switched into a first position and the fourth valve is switched into a first position, wherein only diesel fuel from the first tank can be fed to the fuel inflow of the injection pump and diesel fuel from the fuel return of the injection pump can be fed only to the fuel inlet of the first tank,

q) wherein in a second state of the fuel line system, the first valve is switched into a second position, the second valve is switched into an open position, the third valve is switched into a second position and the fourth valve is switched into a first position, wherein diesel fuel from the first tank and vegetable oil and/or fat from the second tank can be fed to the mixing valve and the mixture from the mixing valve can be fed to the fuel inflow of the injection pump and the mixture from the fuel return of the injection pump can be fed only to the fuel inlet of the third tank, and

r) wherein in a third state of the fuel line system, the first valve is switched into a first position or second position, the second valve is switched into a closed position, the third valve is switched into a second position and the fourth valve is switched into a second position, wherein only the mixture of diesel fuel and vegetable oil and/or fat from the third tank can be fed to the fuel inflow of the injection pump and the mixture from the fuel return of the injection pump can be fed only to the fuel inlet of the third tank.

The advantages correspond to the advantages explained on the basis of claim 1.

It is also advantageous if, in a fourth state of the fuel line system, the first valve is switched into a first position, the second valve is switched into a closed position, the third valve is switched into a second position and the fourth valve is switched into a first position, wherein only diesel fuel from the first tank can be fed to the fuel inflow of the injection pump and diesel fuel and/or remaining mixture residues from the fuel return of the injection pump can be fed only to the fuel inlet of the third tank.

It is expediently provided according to one variant that at least one first heating device for heating the fuel, in particular an electrically operable heating device, is integrated into the connection between the second tank and the second valve and/or into the connection between the second valve and the mixing valve.

It is also advantageous to integrate at least one filter into the connection between the second tank and the second valve and/or into the connection between the second valve and the mixing valve.

Also preferable is a refinement of the fuel supply device in which at least one second heating device for heating the fuel, in particular an electrically operable heating device, is integrated into the connection between the fourth valve and the fuel inflow of the injection pump.

The fuel supply device as claimed in claim 17 (this is preferably one of the fuel supply devices described above), likewise for a diesel engine having at least one injection pump (also: injection system, injection device) which supplies an injection nozzle with fuel and which has a fuel inflow and a fuel return, comprises

a) at least one first tank for diesel fuel,

b) at least one second tank for vegetable oil and/or vegetable fat, in particular used vegetable oil and/or fat,

c) at least one third tank for holding a mixture of the diesel fuel and the vegetable oil and/or fat,

d) wherein each of the at least three tanks has at least one fuel outlet,

e) a fuel line system, which comprises fuel lines and fuel valves, between the tanks and the injection pump,

f) a mixing valve having a diesel input and a vegetable oil and/or fat input and a mixture input and a fuel output,

g) wherein in a diesel position of the mixing valve, only the diesel input is flow-connected to the fuel output,

h) wherein in a mixing position of the mixing valve, the diesel input and the vegetable oil and/or fat input but not the mixture input are flow-connected to the fuel output,

i) wherein in a mixture position of the mixing valve, only the mixture input is flow-connected to the fuel outlet,

j) wherein the fuel outlet of the first tank is connected to the diesel input of the mixing valve,

k) wherein the fuel outlet of the second tank is connected to the vegetable oil and/or fat input of the mixing valve,

l) wherein a fuel inlet of the first tank and a fuel inlet of the third tank are connected to a seventh valve, in particular a 3/2 directional control valve,

m) wherein the mixing valve is connected to the fuel inflow of the injection pump,

n) wherein the fuel return of the injection pump is connected to the seventh valve, and

o) a control unit for controlling the fuel flow through the fuel line system,

p) wherein in a first state of the fuel line system, the mixing valve is switched into the diesel position and the seventh valve is switched into a first position, wherein only diesel fuel from the first tank can be fed to the fuel inflow of the injection pump and diesel fuel from the fuel return of the injection pump can be fed only to the fuel inlet of the first tank,

q) wherein in a second state of the fuel line system, the mixing valve is switched into the mixing position and the seventh valve is switched into a second position, wherein diesel fuel from the first tank and vegetable oil and/or fat from the second tank can be fed to the mixing valve and the mixture from the mixing valve can be fed to the fuel inflow of the injection pump and the mixture from the fuel return of the injection pump can be fed only to the fuel inlet of the third tank, and

r) wherein in a third state of the fuel line system, the mixing valve is switched into the mixture position and the seventh valve is switched into the second position, wherein only the mixture of diesel fuel and vegetable oil and/or fat from the third tank can be fed to the fuel inflow of the injection pump and the mixture from the fuel return of the injection pump can be fed only to the fuel inlet of the third tank.

The advantages can be gathered largely from the advantages explained on the basis of claim 1. It should additionally be stated that the mixing valve provided here as one component not only assumes the task of producing the fuel mixture from the starting fuels, but rather also permits the targeted supply of the desired fuel type (diesel fuel, vegetable oil or fat, mixture). For this purpose, the mixing valve, controlled by the control unit, assumes different positions (diesel position, mixing position, mixture position). The construction is thereby considerably simpler and more straightforward than in the fuel supply device explained previously; fewer valves and connecting lines are necessary. This simplifies production and reduces production costs.

It is also advantageous if, in a fourth state of the fuel line system, the mixing valve is switched into the diesel position and the seventh valve is switched into the second position, wherein only diesel fuel from the first tank can be fed to the fuel inflow of the injection pump and diesel fuel and/or remaining mixture residues from the fuel return of the injection pump can be fed only to the fuel inlet of the third tank.

The fuel supply device as claimed in claim 19 (this is preferably one of the fuel supply devices described above), likewise for a diesel engine having at least one injection pump (also: injection system, injection device) which supplies an injection nozzle with fuel and which has a fuel inflow and a fuel return, comprises

a) at least one first tank for diesel fuel,

b) at least one second tank for vegetable oil and/or vegetable fat, in particular used vegetable oil and/or fat,

c) at least one third tank for holding a mixture of the diesel fuel and the vegetable oil and/or fat,

d) wherein each of the at least three tanks has at least one fuel outlet,

e) a fuel line system, which comprises fuel lines and fuel valves, between the tanks and the injection pump,

f) a mixing valve having a diesel input and a vegetable oil and/or fat input and a mixture input and a fuel output,

g) wherein the fuel outlet of the first tank is connected to an eighth valve, in particular a 3/2 directional control valve,

h) wherein the eighth valve is connected to the diesel input of the mixing valve and to the fuel inflow of the injection pump,

i) wherein in a mixing position of the mixing valve, the diesel input and the vegetable oil and/or fat input but not the mixture input are flow-connected to the fuel output,

j) wherein in a mixture position of the mixing valve, only the mixture input is flow-connected to the fuel outlet,

k) wherein the fuel outlet of the second tank is connected to the vegetable oil and/or fat input of the mixing valve,

l) wherein a fuel inlet of the first tank and a fuel inlet of the third tank are connected to a seventh valve, in particular a 3/2 directional control valve,

m) wherein the mixing valve is connected to the fuel inflow of the injection pump,

n) wherein the fuel return of the injection pump is connected to the seventh valve, and

o) a control unit for controlling the fuel flow through the fuel line system,

p) wherein in a first state of the fuel line system, the eighth valve is switched into a first position and the vegetable oil and/or fat input and the mixture input of the mixing valve are switched into a closed position and the seventh valve is switched into a first position, wherein only diesel fuel from the first tank can be fed to the fuel inflow of the injection pump and diesel fuel from the fuel return of the injection pump can be fed only to the fuel inlet of the first tank,

q) wherein in a second state of the fuel line system, the eighth valve is switched into a second position and the mixing valve is switched into the mixing position and the seventh valve is switched into a second position, wherein diesel fuel from the first tank and vegetable oil and/or fat from the second tank can be fed to the mixing valve and the mixture from the mixing valve can be fed to the fuel inflow of the injection pump and the mixture from the fuel return of the injection pump can be fed only to the fuel inlet of the third tank, and

r) wherein in a third state of the fuel line system, the eighth valve is switched into a second position and the mixing valve is switched into the mixture position and the seventh valve is switched into the second position, wherein only the mixture of diesel fuel and vegetable oil and/or fat from the third tank can be fed to the fuel inflow of the injection pump and the mixture from the fuel return of the injection pump can be fed only to the fuel inlet of the third tank.

The advantages can be gathered largely from the advantages already described on the basis of the preceding embodiment variants of the invention.

It is also advantageous if, in a fourth state of the fuel line system, the eighth valve is switched into a first position and the vegetable oil and/or fat input and the mixture input of the mixing valve are switched into a closed position and the seventh valve is switched into the second position, wherein only diesel fuel from the first tank can be fed to the fuel inflow of the injection pump and diesel fuel and/or remaining mixture residues from the fuel return of the injection pump can be fed only to the fuel inlet of the third tank.

It is expediently provided in one refinement of the two latter variants of the invention that one or more heating devices for heating the fuel, in particular electrically operable heating devices and/or heat exchangers which transfer heat from the fuel returning from the injection pump to the fuel flowing to the injection pump, are integrated into the second tank and/or into the connection between the second tank and the mixing valve and/or into the connection between the mixing valve and the injection pump. The latter variant is particularly preferable since the already-existing heat of the returning fuel is utilized here. Energy sources outside the fuel supply devices, for example batteries or alternators or else the engine cooling water which is heated by the engine, need not be tapped.

It is also advantageous to integrate at least one filter into the connection between the second tank and the mixing valve.

It is particularly expedient and advantageous in all of the above-described embodiments of a fuel supply device for a sensor for measuring the filling level of the third tank, in particular a float sensor and/or a float switch, to be provided in the third tank.

The fuel supply device according to the invention is preferably designed and intended to be retrofitted to a diesel engine. In this way, it is possible to convert a large number of already-existing diesel engines, in particular in motor vehicles and boats, for permanent and reliable operation with vegetable fuel. Here, operation with vegetable fuel is to be understood to mean any period of operation in which vegetable fuel is also used among others for operating the engine. Here, it is not detrimental to the invention if, in certain operating phases, only diesel fuel is used or if a mixture of vegetable fuel and diesel fuel is used.

Claim 25 specifies a diesel engine having at least one injection pump which comprises a fuel supply device according to the invention as described above.

Claim 26 proposes a method for operating a fuel supply device for a diesel engine having at least one injection pump, in particular one of the fuel supply devices described above,

a) wherein the fuel supply device comprises

a1) at least one first tank for diesel fuel,

a2) at least one second tank for vegetable oil and/or vegetable fat, in particular used vegetable oil and/or fat,

a3) at least one third tank for holding a mixture of the diesel fuel and the vegetable oil and/or fat,

a4) a fuel line system, which comprises fuel lines and fuel valves, between the tanks and the injection pump,

a5) a control unit for controlling the fuel flow through the fuel line system,

b) in which method, when the diesel engine is started until the operating temperature of the diesel engine, in particular approximately 80° C. to approximately 95° C., preferably approximately 87° C. to approximately 90° C., is reached, in a first state of the fuel supply device, diesel fuel from the first tank is fed to the injection pump and diesel fuel from the injection pump is fed only to the first tank,

c) in which method, after the operating temperature of the diesel engine is reached, in a second operating state of the fuel supply device, diesel fuel from the first tank and vegetable oil and/or fat from a second tank are mixed, in particular in a mixing valve, and subsequently only the mixture is fed to the injection pump and the mixture from the injection pump is fed to the third tank, specifically until a predefined upper filling level in the third tank is reached or exceeded,

d) in which method, after the predefined upper filling level in the third tank is reached or exceeded until a predefined lower filling level in the third tank is reached or undershot, in a third operating state of the fuel supply device, only the mixture of diesel fuel and vegetable oil and/or fat from the third tank is fed to the injection pump and the mixture from the injection pump is fed only to the third tank,

e) in which method, after the predefined lower filling level is reached or undershot again until the predefined upper filling level is reached or exceeded, in the second operating state again, diesel fuel from the first tank and vegetable oil and/or fat from a second tank are mixed, in particular in a mixing valve, and subsequently the mixture is fed to the injection pump and the mixture from the injection pump is fed only to the third tank,

f) in which method the fuel supply device is subsequently operated further in alternation between step d) and step e), specifically until a shut-down phase of the diesel engine is initiated or until the diesel engine is shut down.

The advantages of the method can be gathered from the above-described advantages of the fuel supply device according to the invention.

According to one refinement of the method, it is provided that, when a shut-down phase of the diesel engine is initiated, in a fourth operating state of the fuel supply device, only diesel fuel from the first tank is fed to the injection pump and diesel fuel and/or remaining mixture residues from the injection pump fed only to the third tank, specifically for a time which is predefined, in particular as a function of the line volume which is to be flushed. It can additionally be provided that, after the expiry of the predefined time, the diesel engine is finally shut down or, until the final shutdown of the diesel engine, in the first operating state of the fuel supply device, diesel fuel from the first tank is fed to the injection pump and diesel fuel from the injection pump is fed only to the first tank.

A method variant is preferable in which the shutdown phase of the diesel engine is initiated automatically, in particular when a shutdown device is actuated, or manually.

One expedient refinement provides that warning signals, in particular visual and/or audible warning signals, are output for as long as the shutdown phase is not complete. It is also possible to provide that the diesel engine continues running automatically until the completion of the shutdown phase, that is to say, in this phase, the ignition switch (engine cut-out switch) is bypassed.

One expedient refinement, which is advantageous for motor vehicles in particular, provides that the shutdown phase can be initiated only in a park or neutral position of the motor vehicle transmission and/or if no (automatic) gear is engaged.

A refinement of the method is particularly expedient and advantageous in which the filling level in the third tank is determined by means of a sensor, in particular a float sensor and/or a float switch.

Also expedient is a variant in which the vegetable oil and/or fat is heated in the second tank and/or after it passes out of the second tank, and/or the mixture is heated before it enters the injection pump, in particular to approximately 60° C. to 70° C., in particular by means of one or more heating devices, preferably electrically operated heating devices and/or heat exchangers which transfer heat from the fuel returning from the injection pump to the fuel flowing to the injection pump.

A refinement of the method is advantageous in which, in the second operating state of the fuel supply device, during the mixing of the diesel fuel and vegetable oil and/or fat, in particular in a mixing valve, a mixture is generated with a mixing ratio in the range from 7% diesel and 93% vegetable oil and/or fat to 93% diesel and 7% vegetable oil and/or fat, in particular a mixing ratio in the range from 15% diesel and 85% vegetable oil and/or fat to 20% diesel and 80% vegetable oil and/or fat, preferably of approximately 18% diesel and 82% vegetable oil and/or fat.

Claim 33 proposes a method for operating a diesel engine having at least one injection pump and a fuel supply device with vegetable oil and/or fat, in particular used fat, in particular a diesel engine having a fuel supply device as described above and/or a diesel engine as described above, in which method the fuel supply device is operated according to a method as described above.

The invention is explained in more detail below, with regard also to further features and advantages, on the basis of the description of an exemplary embodiment and with reference to the appended drawing, in which:

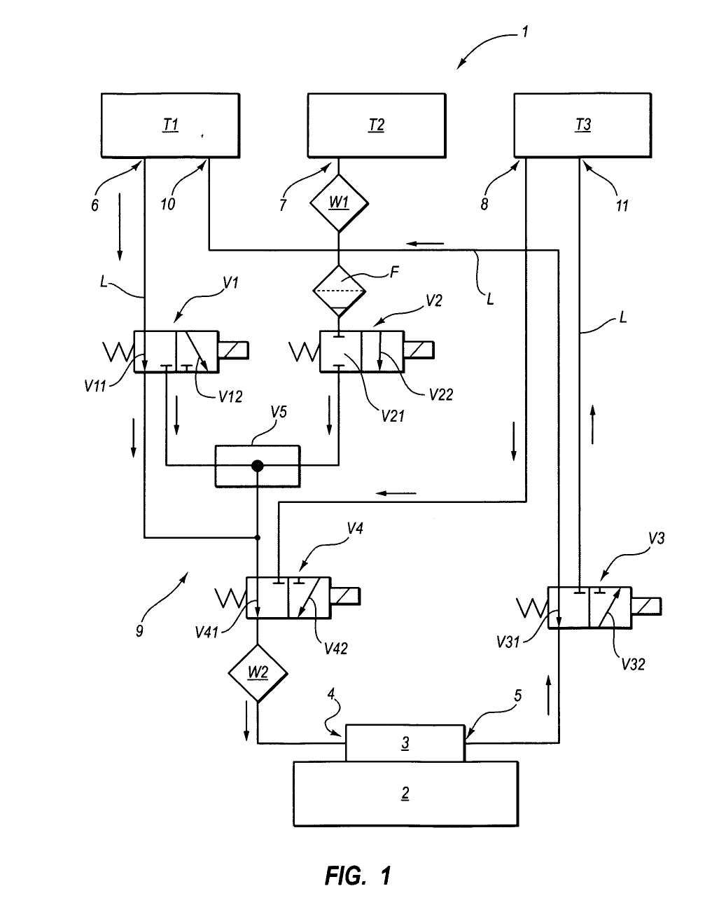

FIG. 1 shows an exemplary embodiment of a fuel supply device according to the invention for a diesel engine having an injection pump;

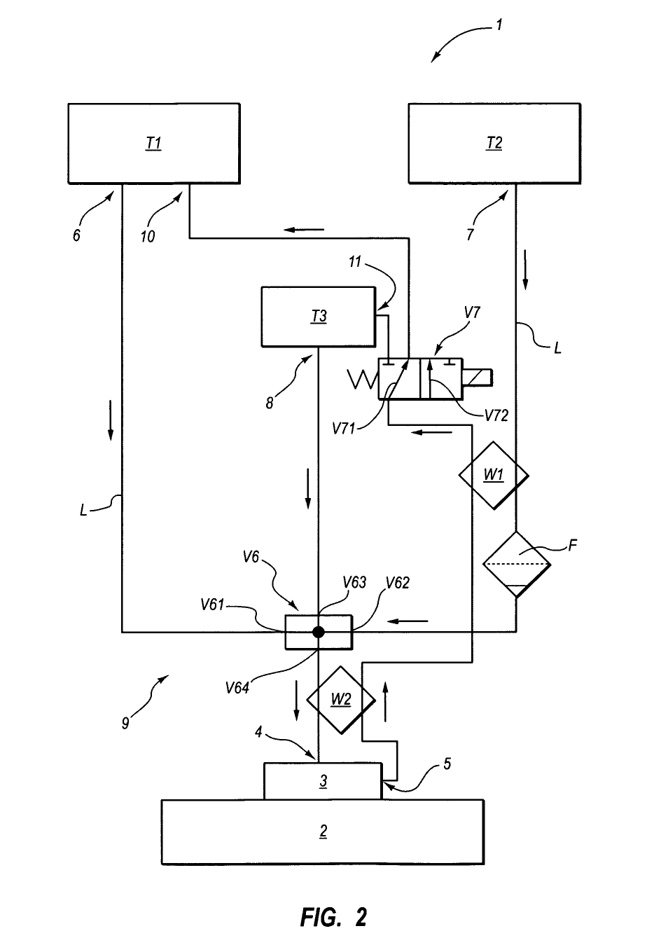

FIG. 2 shows an alternative exemplary embodiment of a fuel supply device according to the invention for a diesel engine having an injection pump;

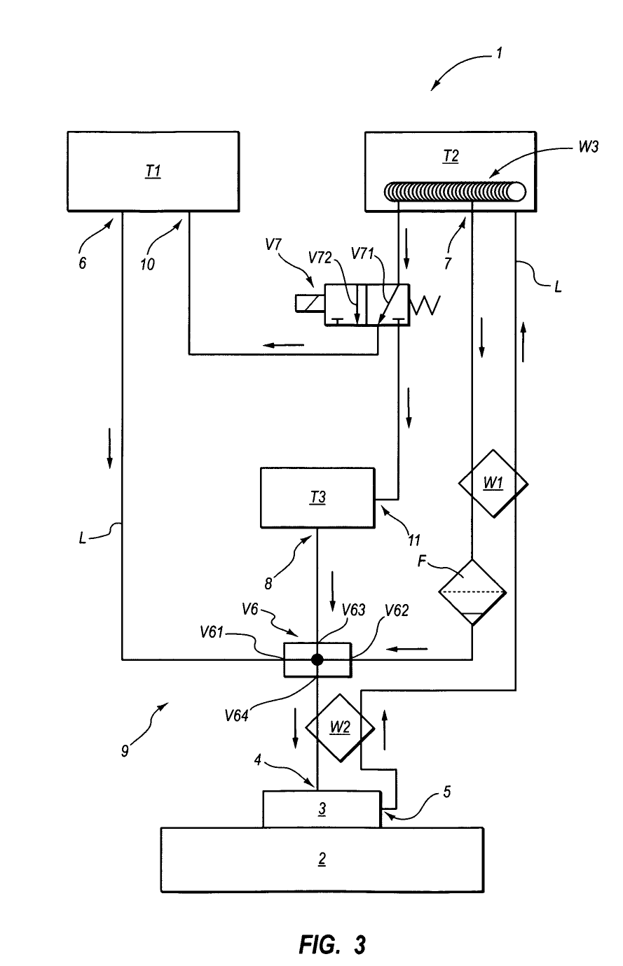

FIG. 3 shows a further alternative exemplary embodiment;

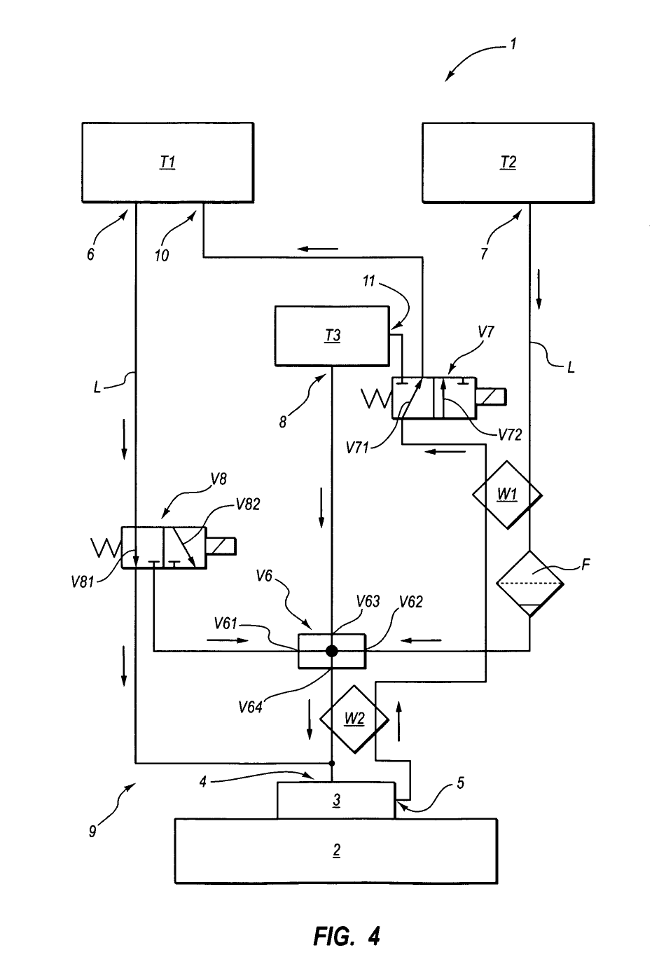

FIG. 4 shows yet a further alternative exemplary embodiment; and

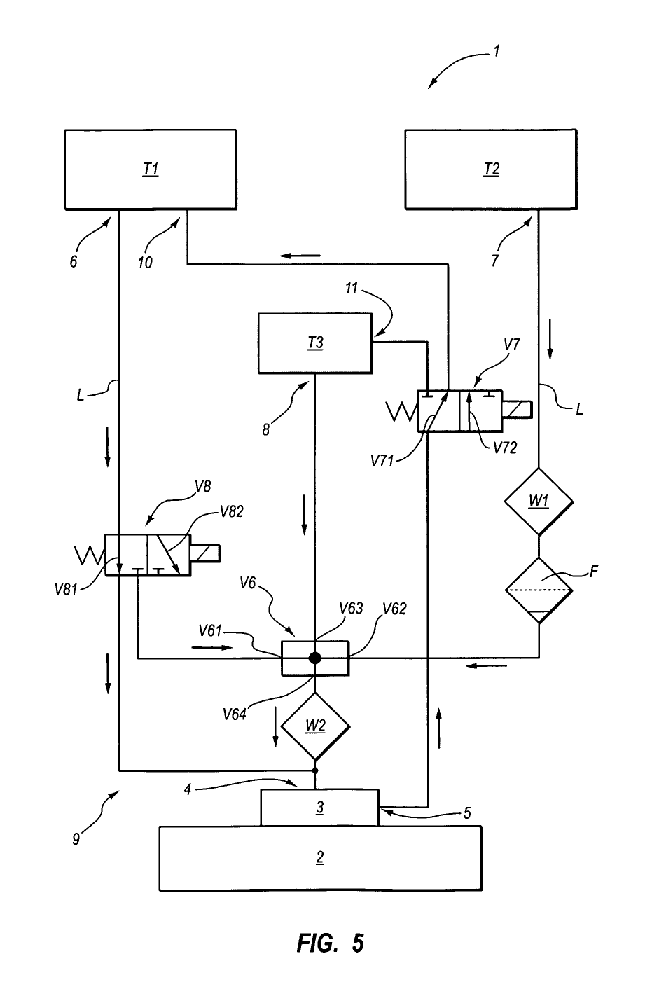

FIG. 5 shows a further alternative exemplary embodiment to the above examples.

Similar parts and components are provided with the same reference symbols in the different exemplary embodiments as per FIG. 1 to FIG. 5.

FIG. 1 shows an exemplary embodiment of a fuel supply device 1 according to the invention for a diesel engine 2 having an injection pump 3. The injection pump (also injection system) supplies an injection nozzle (not illustrated) with fuel. The injection pump has a fuel inflow 4 and a fuel return 5.

The fuel supply device 1 comprises a first tank T1 for diesel fuel, a second tank T2 for vegetable oil and/or vegetable fat, in particular used vegetable oil and/or fat, and a third tank T3 for holding a mixture of the diesel fuel and the vegetable oil and/or fat. The tank T1 has a fuel outlet 6 and a fuel inlet 10. The second tank T2 has a fuel outlet 7. The third tank T3 has a fuel outlet 8 and a fuel inlet 11.

The vegetable oil or vegetable fat, in particular the used vegetable oil or fat, should expediently be cleaned before being filled into the second tank T2, in order to remove food residues and other impurities such as for example deep-frying oils and fats after their use. Suitable for this purpose are for example multi-purpose filters, preferably mesh filters with a 10 μm mesh. Said filters are washable and therefore have a long service life.

The fuel tanks T1, T2 and T3 are connected by means of a fuel line system 9 to the injection pump 3, with the fuel outlets 6, 7, 8 of all the tanks T1, T2, T3 being connected to the fuel inflow 4 of the injection pump 3 and the fuel return 5 of the injection pump 3 being connected to the fuel inlet 10 of the first tank T1 and to the fuel inlet 11 of the third tank T3.

The fuel line system 9 comprises a plurality of valves V1, V2, V3, V4, V5 and fuel lines L, with the intended fuel flow directions being indicated by arrows on the fuel lines. It is a task of the fuel line system 9 to supply the in each case required or desired fuel from the tanks T1, T2, T3 to the injection pump 3 via the fuel inflow 4, and to return the excess fuel from the injection pump 3 via the fuel return 5 to the in each case intended tank T1, T2, T3.

In order to control the fuel line system 9, a control unit (not illustrated) is provided which serves to control inter alia the valves V1, V2, V3, V4, V5. In addition, a float (also: float switch, not illustrated) is provided in the third tank T3, which float measures the filling of the third tank and signals to the control unit the attainment (or undershooting or exceedance) of a lower or upper predefined position in the third tank T3, that is to say a minimum or maximum predefined filling of the third tank T3.

For the understanding of the following explanation, it should be noted that an x/y directional control valve is to be understood to mean a valve with x ports and y switching states.

In detail, the fuel line system is constructed as follows:

The fuel outlet 6 of the first tank T1 is connected by means of a fuel line L to a first valve V1, a 3/2 directional control valve. The fuel outlet 7 of the second tank T2 is connected to a second valve V2, a 2/2 directional control valve. A first heating device W1 and a filter F, preferably an oil filter with water separation and ventilation, is integrated into said connection.

The filter F is a conventional oil filter. The filter F performs in particular a dewatering and ventilation function.

The first heating device W1 (also heat exchanger) has the task of heating the vegetable oil or vegetable fat after it passes out of the second tank T2, preferably to approximately 60° C. to 70° C. An electrically operated heating device W1 is expediently used.

The fuel inlet 10 of the first tank T1 and the fuel inlet 11 of the third tank T3 are connected to a third valve V3, in particular a 3/2 directional control valve. The first valve V1 is connected to a fourth valve V4, in particular a 3/2 directional control valve. The first valve V1 and second valve V2 are connected to a mixing valve V5.

The mixing valve V5 has the task of mixing diesel fuel from the first tank T1 and vegetable oil and/or fat from the second tank T2 in a predefined, in particular adjustable ratio. The control of the mixing valve can take place electrically and/or electronically and/or mechanically. The mixture is subsequently fed onward to the injection pump. A preferred mixing ratio of the generated mixture is 18% diesel fuel and 82% vegetable oil and/or fat.

The mixing valve V5 is connected to the fourth valve V4. The fuel outlet 8 of the third tank T3 is connected to the fourth valve V4. The fourth valve V4 is connected to the fuel inflow 4 of the injection pump 3. A second heating device (also heat exchanger) is integrated in said connection. Said second heating device has the task of heating the mixture of diesel fuel and vegetable oil or vegetable fat, preferably to approximately 60° C. to 70° C., before it enters the injection pump 3. An electrically operated heating device W2 is expediently also used here. The fuel return 5 of the injection pump 3 is connected to the third valve V3.

The control unit regulates four different states of the fuel line system 9. Said four states are described below:

First state:

First valve V1: first position V11

Second valve V2: closed position V21

Third valve V3: first position V31

Fourth valve V4: first position V41

In the first state of the fuel line system (or first operating state of the fuel supply device), only diesel fuel from the first tank T1 can be fed to the fuel inflow 4 of the injection pump 3 and diesel fuel from the fuel return 5 of the injection pump 3 can be fed only to the fuel inlet 10 of the first tank T1.

In detail, in the first state, diesel fuel from the first tank T1 (diesel tank) flows to the first valve V1 which is in the first position V11. The diesel fuel is therefore conducted onward to the fourth valve V4. The latter is in the position V41 and therefore conducts the fuel onward to the heating device W2. There, the fuel is heated to approximately 60° C. to 70° C. and is fed onward to the fuel inflow 4 of the injection pump 3. The excess fuel flows from the fuel return 5 of the injection pump 3 via the valve V3, which is switched into the first position V31, back into the first tank T1 (diesel tank).

Second state:

First valve V1: second position V12

Second valve V2: open position V22

Third valve V3: second position V32

Fourth valve V4: first position V41

In the second state of the fuel line system (or second operating state of the fuel supply device), diesel fuel from the first tank T1 (diesel tank) and vegetable oil and/or fat from the second tank T2 (vegetable oil and/or fat tank) can be fed to the mixing valve V5. The generated mixture can then be fed from there to the injection pump 3. The mixture can finally be fed from the fuel return 5 of the injection pump 3 only to the fuel inlet 11 of the third tank T3.

In detail, in the second state, diesel fuel from the first tank T1 flows to the first valve V1 which is in the second position V12. The first valve V1 conducts the diesel fuel onward to the mixing valve V5. At the same time, vegetable oil or vegetable fat from the second tank T2 flows through the heating device W1 (electric heat exchanger), in which the fuel is heated to approximately 60° C. to 70° C., to the filter F. From the filter F, the now-filtered fuel flows through the second valve V2, which is switched into an open position V22, to the mixing valve V5.

The mixing valve V5 produces a fuel mixture from the diesel fuel and the vegetable oil or vegetable fat, specifically a fuel mixture with a predefined or predefinable percentaged mixing ratio of the two fuels. Here, the mixing valve V5 can be designed such that the predefined or predefinable mixing ratio is adjustable (also: variable).

The generated mixture is conducted onward from the mixing valve V5 to the fourth valve V4, which is switched into the first position V41. From there, the mixture passes onward to the heating device W2, is heated there to approximately 60° C. to 70° C. and is fed onward to the fuel inflow 4 of the injection pump 3. The excess fuel (the mixture) flows from the fuel return 5 of the injection pump 3 via the valve V3, which is switched into the second position V32, into the third tank T3 (mixture tank) and fills the latter.

The task of the third tank T3 (mixture tank) is that of initially storing the excess fuel mixture and later (third state, see below) providing said excess fuel mixture to the diesel engine once again.

The third tank T3 (mixture tank) is fitted with a float switch (not illustrated) for filling level checking (also: fuel volume checking).

Third state:

First valve V1: first position V11 or second position V12

Second valve V2: closed position V21

Third valve V3: second position V32

Fourth valve V4: second position V42

In the third state of the fuel line system (or third operating state of the fuel supply device), only the mixture of diesel fuel and vegetable oil and/or fat from the third tank T3 can be fed to the fuel inflow 4 of the injection pump 3 and the excess mixture from the fuel return 5 of the injection pump 3 can be fed only to the fuel inlet 11 of the third tank T3.

In detail, the first valve V1 is in any desired position, the second valve V2 is preferably switched into a closed position V21 in order to prevent an undesired fuel flow between the first tank T1 and second tank T2. The mixture from the third tank T3 flows to the fourth valve V4 which is switched into the second position V42. From there, the mixture passes onward to the heating device W2, is heated there to approximately 60° C. to 70° C. and is fed onward to the fuel inflow 4 of the injection pump 3. The excess fuel (the mixture) flows from the fuel return 5 of the injection pump 3 via the valve V3, which is switched into the second position V32, into the third tank T3 (mixture tank).

Fourth state:

First valve V1: first position V11

Second valve V2: closed position V21

Third valve V3: second position V32

Fourth valve V4: first position V41

In the fourth state of the fuel line system (or fourth operating state of the fuel supply device), only diesel fuel from the first tank T1 can be fed to the fuel inflow 4 of the injection pump 3 and the excess diesel fuel and/or remaining mixture residues from the fuel return 5 of the injection pump 3 can be fed only to the fuel inlet 11 of the third tank T3.

There is always a sufficient residual volume available in the third tank T3 for this purpose.

In detail, diesel fuel from the first tank T1 (diesel tank) flows to the first valve V1 which is switched into the first position V11. From there, the fuel is conducted onward to the fourth valve V4 which is switched into the first position V41. From there, the mixture passes onward to the heating device W2, is heated there to approximately 60° C. to 70° C. and is fed onward to the fuel inflow 4 of the injection pump 3. The excess fuel (diesel fuel and/or remaining mixture) flows from the fuel return 5 of the injection pump 3 via the valve V3, which is switched into the second position V32, into the third tank T3 (mixture tank).

The states described above are controlled in succession as follows:

When the diesel engine is started, the fuel supply device is in the first operating state (first state of the fuel line system), that is to say the diesel engine operates in pure diesel operation.

When the operating temperature of the engine is reached, the fuel supply device is switched into the second operating state (second state of the fuel line system), that is to say the diesel engine runs in a first mixture mode and the third tank T3 (mixture tank) is filled.

Once the float in the third tank T3 (mixture tank) has reached its upper predefined position, the fuel supply device is switched into the third operating state (third state of the fuel line system), that is to say the diesel engine continues to run in a mixture mode, specifically a second mixture mode in which the third tank T3 (mixture tank) is emptied.

Once the float in the third tank T3 (mixture tank) has reached its lower predefined position (that is to say the fuel quantity in the third tank T3 has fallen to a low level), the fuel supply device is switched back into the second operating state (second state of the fuel line system), that is to say the diesel engine runs in the first mixture mode again and the third tank T3 (mixture tank) is filled again.

If the third tank, when the operating temperature of the engine in the first operating state is reached, is already filled up to or over the predefined position, then the fuel supply device is switched directly into the third operating state (third state of the fuel line system), and the above-described switch between the third and the second state subsequently takes place when the lower predefined position is reached. This is also possible if the third tank, when the operating temperature of the engine is reached, has duly not yet been filled up to the upper predefined position, but the filling level is above the lower predefined position.

The continuous switching between the second and third operating state or between the first and second mixture modes permits permanent operation of the diesel engine with a mixture of diesel fuel and vegetable oil or vegetable fat, with the mixing ratio being adjustable in order to provide optimum adaptation to the respective diesel engine (by means of corresponding adjustment of the mixing valve V5).

If the ignition key (generally: ignition switch, on-off switch, cut-out switch) of the diesel engine is set to “off”, it can be provided that the control electronics takes over the engine control. Here, the diesel engine is not shut down immediately, but is rather switched from the presently-set second or third operating state of the fuel supply device into the fourth operating state (fourth state of the fuel line system).

The fourth operating state, which can also be referred to as the time delay phase, is designed to discharge the mixture still remaining in the lines and in the injection pump. Since said mixture should not pass into the first tank T1 (diesel tank), it is fed into the third tank T3 (mixture tank). Flushing of the fuel line system 9 and of the injection pump 3 therefore takes place in the fourth state. In this way, the fuel supply device 1 should be placed into a pure diesel state before the complete shutdown of the diesel engine, in order to allow the diesel engine to be switched on in the cold state without problems.

The fourth state is carried out for a time period which is adapted corresponding to the lengths of the lines. Said time period is variably adjustable, in particular electrically and/or electronically and/or manually. A typical time duration is approximately 10 seconds to 120 seconds.

After the expiry of the time duration, the diesel engine can finally be shut down manually or automatically. It is however also possible to switch, for a certain time, preferably automatically into the first operating state of the fuel supply device (first state of the fuel line system) and to thereby operate the diesel engine in the “normal” pure diesel mode. After approximately two to three minutes, the diesel engine is then finally shut down automatically.

The valves V1, V2, V3, V4 are for example commercially available solenoid valves. The control of the valves can take place electrically and/or electronically and/or mechanically.

The setting of the respective operating state of the fuel supply device or of the respective state of the fuel line system takes place by means of corresponding adjustment of the valves V1, V2, V3, V4, for example by means of the control unit. The setting of an operating state or the switching between the operating states takes place as a function of the ignition key position (switching position of the ignition switch, on-off switch) and/or the temperature of the diesel engine (by means of a conventional thermal sensor) and/or the fuel filling of the third tank T3 (mixture tank).

FIG. 2 and FIG. 3 show two further, alternative exemplary embodiments of a fuel supply device 1 according to the invention for a diesel engine 2 having an injection pump 3 (also: injection system). The embodiment variant as per FIG. 2 is designed in particular for use in regions with ambient temperatures which are usually mild or warm all year round, for example in Europe in countries south of the Alps. The embodiment variant as per FIG. 3, in contrast, is designed for regions in which relatively low ambient temperatures also occur at least at times (for example in the winter months), for example in countries north of the Alps or in the Alps themselves. The difference between the two variants lies—as explained in more detail below—in particular in the provision of an additional heating device W3 in the second tank T2 for vegetable oil or vegetable fat.

As in the exemplary embodiment as per FIG. 1, it is also the case in the examples as per FIG. 2 and FIG. 3 that in each case the injection pump (or injection system) supplies an injection nozzle (not illustrated) with fuel. The injection pump 3 has a fuel inflow 4 and a fuel return 5.

The fuel supply device 1 comprises, both in FIG. 2 and in FIG. 3, a first tank T1 for diesel fuel, a second tank T2 for vegetable oil and/or vegetable fat, in particular used vegetable oil and/or fat, and a third tank T3 for holding a mixture of the diesel fuel and the vegetable oil and/or fat. The tank T1 has a fuel outlet 6 and a fuel inlet 10. The second tank T2 has a fuel outlet 7. The third tank T3 has a fuel outlet 8 and a fuel inlet 11.

The fuel tanks T1, T2 and T3 are connected by means of a fuel line system 9 to the injection pump 3, wherein the fuel outlets 6, 7, 8 of all the tanks T1, T2, T3 are or can be connected to the fuel inflow 4 of the injection pump 3 and the fuel return 5 of the injection pump 3 is or can be connected to the fuel inlet 10 of the first tank T1 and to the fuel inlet 11 of the third tank T3.

The fuel line system 9 again comprises fuel lines L, but in contrast to the exemplary embodiment as per FIG. 1, in each case only two valves V6, V7 are provided in FIG. 2 and FIG. 3. The intended fuel flow directions are indicated by arrows on the fuel lines.

It is a task of the fuel line system 9 to supply the in each case required or desired fuel from the tanks T1, T2, T3 to the injection pump 3 via the fuel inflow 4, and to return the excess fuel from the injection pump 3 via the fuel return 5 to the in each case intended tank T1, T2, T3.

In order to control the fuel line system 9, a control unit (not illustrated) is again provided which serves to control inter alia the valves V6 and V7. In addition, a float (also: float switch, not illustrated) is again provided in the third tank T3, which float measures the filling of the third tank and signals to the control unit the attainment (or undershooting or exceedance) of a lower or upper predefined position in the third tank T3, that is to say a minimum or maximum predefined filling of the third tank T3.

In detail, the fuel line system in the exemplary embodiments as per FIG. 2 and FIG. 3 is constructed as follows:

The fuel outlet 6 of the first tank T1 is connected by means of a fuel line L to a mixing valve V6, specifically to the diesel input V61 thereof.

The fuel outlet 7 of the second tank T2 is likewise connected to the mixing valve V6, specifically to the vegetable oil and/or fat input V62 thereof. A first heating device W1 and a filter F are integrated into said connection, with said filter F, as in the example as per FIG. 1, preferably being a conventional oil filter with water separation and ventilation.

As in the exemplary embodiment as per FIG. 1, it is also the case in FIG. 2 and FIG. 3 that the first heating device W1 has the task of heating the vegetable oil or vegetable fat after it passes out of the second tank T2, preferably to approximately 60° C. to 70° C. The heating device W1 in FIG. 2 and FIG. 3 is a heat exchanger W1 which extracts the heat from the heated fuel emerging from the fuel return 5 of the injection pump 3, and uses said heat for heating the vegetable oil or vegetable fat. This is explained in more detail below.

The fuel outlet 8 of the third tank T3 is also connected to the mixing valve V6, specifically to the mixture input V63 thereof.

The output V64 of the mixing valve V6 is connected to the fuel inflow 4 of the injection pump 3. A second heating device W2 is integrated in said connection. Said second heating device W2, as in the example as per FIG. 1, also has the task in FIG. 2 and FIG. 3 of heating the fuel before it enters the injection pump 3, preferably to approximately 60° C. to 70° C.

Here, the second heating device W2 in FIG. 2 and FIG. 3 is a heat exchanger W2 which, like the heat exchanger W1, extracts the heat from the heated fuel emerging from the fuel return 5 of the injection pump 3, and uses said heat for heating the fuel before it enters the injection pump 3. This is explained in more detail below.

The mixing valve V6 therefore has three inputs V61, V62, V63 and one output V64, with it being possible for the inputs V61, V62, V63 to be connected to the output in various combinations depending on the position of the mixing valve V6, as is explained below.

In a diesel position of the mixing valve V6, only the diesel input V61 is flow-connected to the fuel output V64, and the vegetable oil and/or fat input V62 and the mixture input V63 are closed. This means that, in the diesel position, only diesel fuel from the first tank T1 passes via the mixing valve V6 to the injection pump 3. In a mixing position of the mixing valve V6, both the diesel input V61 and the vegetable oil and/or fat input V62 are flow-connected to the output V64, and the mixture input V63 is closed. This means that, in the mixing position, diesel fuel from the first T1 and vegetable oil and/or fat from the second tank T2 are mixed in the mixing valve V6 and pass via the output V64 to the injection pump 3. Here, the desired mixing ratio can be set at the mixing valve or is predefined by the mixing valve, for example by means of the opening cross section at the inputs V61, V62. A preferred mixing ratio of the mixture generated in the mixing valve V6 is also 18% diesel fuel and 82% vegetable oil and/or fat here.

In a mixture position of the mixing valve V6, the mixture input V63 is flow-connected to the output V64, and the diesel input V61 and the vegetable oil and/or fat input V62 are closed. This means that, in the mixture position, only fuel mixture from the third tank T3 passes via the mixing valve V6 to the injection pump 3.

The mixing valve V6 can be a known, commercially available mixing valve. The control of the mixing valve V6 can take place electrically and/or electronically and/or mechanically. Mentioned as an example is a ball valve mixing valve with three inputs (also: inflows, inlets) and one output (also: outflow, outlet).

One of the significant differences of the exemplary embodiment as per FIG. 2 and FIG. 3 from the exemplary embodiment as per FIG. 1 is in the mixing valve V6. The mixing valve V6 in FIG. 2 and FIG. 3 encompasses the functions of the mixing valve V5 and of the first valve V1, of the second valve V2 and of the fourth valve V4 in FIG. 1. The task of said mixing valve V6 is therefore not only to generate the desired mixture from the pure starting fuels but rather also to conduct the pure starting fuels and the fuel mixture in a targeted fashion to the injection pump 3.

As already discussed, in FIG. 2 and FIG. 3, the fuel return 5 of the injection pump 3 is connected by means of the heat exchanger W2 and the heat exchanger W1 to a seventh valve V7, in particular a 3/2 directional control valve. This is a further significant difference from the exemplary embodiment as per FIG. 1. In FIG. 2 and FIG. 3, the heating devices W1 and W2 are embodied as heat exchangers which utilize the already-existing high return temperature of the fuel after it leaves the injection pump 3. This makes it possible to dispense with expensive electric fuel heaters which load the battery and the alternator of the vehicle or boot. A further alternative to this would be heat exchangers which utilize the waste heat of the engine for heating the fuel, for example by means of the engine cooling water being conducted through the heat exchanger. Said alternative however requires an additional pump and an additional construction which is susceptible to faults. In addition, the engine waste heat is not available during the warm-up period of the engine, which is comparatively long in the case of diesel engines. The solution proposed in FIG. 2 and FIG. 3, by means of heat exchangers W1, W2 which directly “tap” the high fuel temperature (conventionally in the range from 80° C. to 100° C., in particular in the range from 85° C. to 95° C.) after it passes through the injection pump 3, is therefore the best solution for the required fuel heating. Said solution is simple to implement by means of commercially available plate-type heat exchangers, requires no servicing and does not load the battery and/or the alternator of the vehicle or boat.

In addition, the difference between the exemplary embodiment as per FIG. 2 and the exemplary embodiment as per FIG. 3 is in the connection between the fuel return 5 of the injection pump 3 and the seventh valve V7. In FIG. 2, the fuel line downstream of the heat exchanger W1 is guided directly to the seventh valve V7. In FIG. 3, in contrast, the fuel line is guided through a further (third) heating device W3 in the second tank T2 for vegetable oil and/or vegetable fat. The heating device W3 is a heat exchanger W3 which dissipates heat from the recirculated fuel to the vegetable oil and/or vegetable fat in the second tank T2 and thereby pre-heats said vegetable oil and/or vegetable fat. Said heat exchanger W3 can for example be embodied as a spiral line in the second tank T2. Corresponding structural units are known; the spiral line can be composed for example of metal and/or plastic.

The provision of said additional heat exchanger W3 is advantageous in the operation of the fuel supply device 1 at low ambient temperatures, since the high viscosity of the vegetable oil or vegetable fat at low temperatures as mentioned in the introduction has an adverse effect in this case, and this is prevented by means of pre-heating already in the second tank T2. It is accordingly clear that the embodiment variant as per FIG. 3 is suitable in particular for use in regions in which low temperatures can also occur, such as for example in Europe in the winter months in countries north of the Alps or in the Alps themselves. In regions with temperatures which are mild or warm all year round, in contrast, it is possible to save on the costs generated by the additional heat exchanger W3, as the latter is not necessary here even for optimum operation. Accordingly, the exemplary embodiment as per FIG. 2 is suitable for use for example in countries south of the Alps. Corresponding to the respective application ambient conditions, the exemplary embodiment as per FIG. 2 can also be referred to as a “summer variant” and the exemplary embodiment as per FIG. 3 can also be referred to as a “winter variant”. The winter variant is more complex and therefore more expensive to produce in particular on account of the additional components, though said winter variant can of course also be used in regions for which the summer variant is actually also sufficient.

FIG. 2 and FIG. 3 also show that the seventh valve V7 is also connected to the fuel inlet 10 of the first tank T1 and to the fuel inlet 11 of the third tank T3, wherein in a first position V71 of the seventh valve V7, the fuel is fed to the first tank T1, and in a second position V72, the fuel is fed to the third tank T3.

It is also the case in the exemplary embodiments as per FIG. 2 and FIG. 3 that the control unit regulates four different states of the fuel line system 9. Said four states are described below (they apply equally to FIG. 2 and FIG. 3):

First state:

Mixing valve V6: diesel position (V61 open; V62, V63 closed)

Seventh valve V7: first position V71

In the first state of the fuel line system (or first operating state of the fuel supply device), only diesel fuel from the first tank T1 can be fed to the fuel inflow 4 of the injection pump 3 and diesel fuel from the fuel return 5 of the injection pump 3 can be fed only to the fuel inlet 10 of the first tank T1.

In detail, in the first state, diesel fuel from the first tank T1 (diesel tank) flows to the diesel input V61 of the mixing valve V6, which is in the diesel position. In the mixing valve V6, the diesel fuel is conducted to the output V64 and from there to the heat exchanger W2. There, the diesel fuel (with the exception of a short time period when the engine is started, that is to say until warm returning fuel is available in the heat exchanger W2) is heated to approximately 60° C. to 70° C. and is fed onward to the fuel inflow 4 of the injection pump 3 (note: heating of the diesel fuel in the heat exchanger W2 is ultimately not important, since diesel fuel can be used in the injection pump even without being heated, in contrast to vegetable oil or vegetable fat). The excess fuel flows from the fuel return 5 of the injection pump 3 via the valve V7, which is switched into the first position V71, back into the first tank T1 (diesel tank). Here, the warm returned fuel dissipates heat into the heat exchangers W1, W2 and if appropriate (winter variant in FIG. 3) W3.

Second state:

Mixing valve V6: mixing position (V61, V62 open; V63 closed)

Seventh valve V7: second position V72

In the second state of the fuel line system (or second operating state of the fuel supply device), diesel fuel from the first tank T1 (diesel tank) and vegetable oil and/or fat from the second tank T2 (vegetable oil and/or fat tank) can be fed to the mixing valve V6, which is in its mixing position, so that a fuel mixture in the set mixing ratio emerges at the output V64 of said mixing valve V6. The generated mixture can then be fed from there to the injection pump 3. The mixture can finally be fed from the fuel return 5 of the injection pump 3 only to the fuel inlet 11 of the third tank T3.

In detail, in the second state, diesel fuel from the first tank T1 flows to the diesel input V61 of the mixing valve V6. At the same time, vegetable oil or vegetable fat (which, in the winter variant as per FIG. 3, has already been pre-heated by the heat exchanger W3) from the second tank T2 flows through the heat exchanger W1 (electric heat exchanger), in which the fuel is heated to approximately 60° C. to 70° C., to the filter F.

The heating upstream of the filter F is important, since the viscidity of the vegetable oil or vegetable fat at low temperatures can hinder or block the throughflow through the filter. Here, it is advantageous if the heat exchanger W1 and filter F form a structural unit, for example are screwed to one another. In this case, the filter itself is advantageously also heated by the heat exchanger, and its functionality is thereby improved.

From the filter F, the now-filtered fuel flows to the vegetable oil or fat input V62 of the mixing valve V6.

The mixing valve V6 produces a fuel mixture from the diesel fuel and the vegetable oil or vegetable fat, specifically a fuel mixture with a predefined or predefinable percentaged mixing ratio of the two fuels. Here, the mixing valve V6 can be designed such that the predefined or predefinable mixing ratio is adjustable (also: variable).

The generated mixture is conducted onward from the output V64 of the mixing valve V6 to the heat exchanger W2, is heated there to approximately 60° C. to 70° C. and is fed onward to the fuel inflow 4 of the injection pump 3. The excess fuel (the mixture) flows from the fuel return 5 of the injection pump 3 via the valve V7, which is switched into the second position V72, into the third tank T3 (mixture tank) and fills the latter. Here, the warm fuel dissipates heat into the heat exchangers W1, W2 and if appropriate (winter variant in FIG. 3) W3.

The task of the third tank T3 (mixture tank) is that of initially storing the excess fuel mixture and later (third state, see below) providing said excess fuel mixture to the diesel engine once again.

The third tank T3 (mixture tank) is again fitted with a float switch (not illustrated) for filling level checking (also: fuel volume checking).

Third state:

Mixing valve V6: mixture position (V61, V62 closed; V63 open)

Seventh valve V7: second position V72

In the third state of the fuel line system (or third operating state of the fuel supply device), only the mixture of diesel fuel and vegetable oil and/or fat from the third tank T3 can be fed to the fuel inflow 4 of the injection pump 3 and the excess mixture from the fuel return 5 of the injection pump 3 can be fed only to the fuel inlet 11 of the third tank T3.

In detail, in the third state, the mixture from the third tank T3 flows to the mixture input V63 of the mixing valve V6, which is switched into the mixture position. The mixture passes onward via the output V64 of the mixing valve V6 to the heat exchanger W2, is heated there to approximately 60° C. to 70° C. and is fed onward to the fuel inflow 4 of the injection pump 3. The excess fuel (the mixture) flows from the fuel return 5 of the injection pump 3 via the valve V7, which is switched into the second position V72, into the third tank T3 (mixture tank), and in the process, dissipates heat into the heat exchangers W1, W2 and if appropriate (winter variant in FIG. 3) W3.

Fourth state:

Mixing valve V6: diesel position (V61 open; V62, V63 closed)

Seventh valve V7: second position V72

In the fourth state of the fuel line system (or fourth operating state of the fuel supply device), only diesel fuel from the first tank T1 can be fed to the fuel inflow 4 of the injection pump 3 and the excess diesel fuel and/or remaining mixture residues from the fuel return 5 of the injection pump 3 can be fed only to the fuel inlet 11 of the third tank T3. There is always a sufficient residual volume, which can still be filled, available in the third tank T3 for this purpose.

In detail, in the fourth state, diesel fuel from the first tank T1 (diesel tank) flows to the diesel input V61 of the mixing valve V6, which is in the diesel position. In the mixing valve V6, the diesel fuel is conducted to the output V64 and from there to the heat exchanger W2. There, the diesel fuel is heated there to approximately 60° C. to 70° C. and is fed onward to the fuel inflow 4 of the injection pump 3. The excess fuel (diesel fuel and/or remaining mixture) flows from the fuel return 5 of the injection pump 3 via the valve V7, which is switched into the second position V72, into the third tank T3 (mixture tank).

The above-described states of the embodiment variants as per FIG. 2 and FIG. 3 are, similarly to the exemplary embodiment as per FIG. 1, controlled in succession as follows:

When the diesel engine is started, the fuel supply device is in the first operating state (first state of the fuel line system), that is to say the diesel engine operates in pure diesel operation.

When the operating temperature of the engine (for example 87° C.) is reached, the fuel supply device is switched into the second operating state (second state of the fuel line system), that is to say the diesel engine runs in a first mixture mode and the third tank T3 (mixture tank) is filled.

Once the float in the third tank T3 (mixture tank) has reached its upper predefined position, the fuel supply device is switched into the third operating state (third state of the fuel line system), that is to say the diesel engine continues to run in a mixture mode, specifically a second mixture mode in which the third tank T3 (mixture tank) is emptied.

Once the float in the third tank T3 (mixture tank) has reached its lower predefined position (that is to say the fuel quantity in the third tank T3 has fallen to a low level), the fuel supply device is switched back into the second operating state (second state of the fuel line system), that is to say the diesel engine runs in the first mixture mode again and the third tank T3 (mixture tank) is filled again.

If the third tank, when the operating temperature of the engine in the first operating state is reached, is already filled up to or over the predefined position, then the fuel supply device is switched directly into the third operating state (third state of the fuel line system), and the above-described switch between the third and the second state subsequently takes place when the lower predefined position is reached. This is also possible if the third tank, when the operating temperature of the engine is reached, has duly not yet been filled up to the upper predefined position, but the filling level is above the lower predefined position.

The continuous switching between the second and third operating state or between the first and second mixture modes permits permanent operation of the diesel engine with a mixture of diesel fuel and vegetable oil or vegetable fat, with the mixing ratio being adjustable in order to provide optimum adaptation to the respective diesel engine (by means of corresponding adjustment of the mixing valve V6).

If the ignition key (generally: ignition switch, on-off switch, cut-out switch) of the diesel engine is set to “off”, it can also be provided in the exemplary embodiments as per FIG. 2 and FIG. 3 that the control electronics takes over the engine control. Here, the diesel engine is not shut down immediately, but is rather switched from the presently-set second or third operating state of the fuel supply device into the fourth operating state (fourth state of the fuel line system).

As already explained with regard to the exemplary embodiment as per FIG. 1, the fourth operating state, which can also be referred to as the time delay phase, is designed to discharge the mixture still remaining in the lines and in the injection pump. Since said mixture should not pass into the first tank T1 (diesel tank), it is fed into the third tank T3 (mixture tank). Flushing of the fuel line system 9 and of the injection pump 3 therefore takes place in the fourth state. In this way, the fuel supply device 1 should be placed into a pure diesel state before the complete shutdown of the diesel engine, in order to allow the diesel engine to be switched on in the cold state without problems. The fourth state is carried out for a time period which is adapted corresponding to the lengths of the lines. Said time period is variably adjustable, in particular electrically and/or electronically and/or manually. Said time period is longer in the winter variant as per FIG. 3 than in the summer variant as per FIG. 2, since in the winter variant, considerably longer fuel lines are necessary overall, and therefore a greater volume must be flushed, on account of the additional heat exchanger W3 in the second tank T2.

After the expiry of the time duration, the diesel engine can finally be shut down manually or automatically. It is however also possible to switch, for a certain time, preferably automatically into the first operating state of the fuel supply device (first state of the fuel line system) and to thereby operate the diesel engine in the “normal” pure diesel mode. After approximately two to three minutes, the diesel engine is then finally shut down automatically.

The valve V7 is for example a commercially available solenoid valve. The control of the valve V7 can take place electrically and/or electronically and/or mechanically.

The setting of the respective operating state of the fuel supply device or of the respective state of the fuel line system takes place by means of corresponding adjustment of the valves V6, V7, for example by means of the control unit. The setting of an operating state or the switching between the operating states takes place as a function of the ignition key position (switching position of the ignition switch, on-off switch) and/or the temperature of the diesel engine (by means of a conventional thermal sensor) and/or the fuel filling of the third tank T3 (mixture tank).

FIG. 4 and FIG. 5 show two further, alternative exemplary embodiments of a fuel supply device 1 according to the invention for a diesel engine 2 having an injection pump 3. The embodiment variant as per FIG. 4 can be gathered from the embodiment variant as per FIG. 2. The difference is in particular in the provision of an additional eighth valve V8 between the first tank T1 and the mixing valve V6. This results in a fuel connection, which runs parallel to the mixing valve V6, to the injection pump 3. The exemplary embodiment as per FIG. 5 is a modification of the exemplary embodiment as per FIG. 4. The difference is in the arrangement and design of the heating devices W1 and W2. This is explained in more detail below.

As in the above-described exemplary embodiments, it is also the case in the examples as per FIG. 4 and FIG. 5 that in each case the injection pump (or injection system) supplies an injection nozzle (not illustrated) with fuel. The injection pump 3 has a fuel inflow 4 and a fuel return 5.

The fuel supply device 1 again comprises, both in FIG. 4 and in FIG. 5, a first tank T1 for diesel fuel, a second tank T2 for vegetable oil and/or vegetable fat, in particular used vegetable oil and/or fat, and a third tank T3 for holding a mixture of the diesel fuel and the vegetable oil and/or fat. The tank T1 has a fuel outlet 6 and a fuel inlet 10. The second tank T2 has a fuel outlet 7. The third tank T3 has a fuel outlet 8 and a fuel inlet 11.

The fuel tanks T1, T2 and T3 are connected by means of a fuel line system 9 to the injection pump 3, wherein the fuel outlets 6, 7, 8 of all the tanks T1, T2, T3 are or can be connected to the fuel inflow 4 of the injection pump 3 and the fuel return 5 of the injection pump 3 is or can be connected to the fuel inlet 10 of the first tank T1 and to the fuel inlet 11 of the third tank T3.

The fuel line system 9 again comprises fuel lines L, and three valves V6, V7, V8 are also provided both in the example as per FIG. 4 and in the example as per FIG. 5. The intended fuel flow directions are indicated by arrows on the fuel lines.

It is a task of the fuel line system 9 to supply the in each case required or desired fuel from the tanks T1, T2, T3 to the injection pump 3 via the fuel inflow 4, and to return the excess fuel from the injection pump 3 via the fuel return 5 to the in each case intended tank T1, T2, T3.

In order to control the fuel line system 9, a control unit (not illustrated) is again provided which serves to control inter alia the valves V6, V7 and V8. In addition, a float (not illustrated) is again provided in the third tank T3, which float measures the filling of the third tank and signals to the control unit the attainment (or undershooting or exceedance) of a lower or upper predefined position in the third tank T3, that is to say a minimum or maximum predefined filling of the third tank T3.

In detail, the fuel line system in the exemplary embodiments as per FIG. 4 and FIG. 5 is constructed as follows:

The fuel outlet 6 of the first tank T1 is connected by means of a fuel line L to an eighth valve V8, a 3/2 directional control valve, as already briefly discussed above.

The fuel outlet 7 of the second tank T2 is likewise connected to the mixing valve V6, specifically to the vegetable oil and/or fat input V62 thereof. A first heating device W1 and a filter F are integrated into said connection, with said filter F, as in the preceding examples, preferably being a conventional oil filter with water separation and ventilation.

The first heating device W1 again has the task of heating the vegetable oil or vegetable fat after it passes out of the second tank T2, preferably to approximately 60° C. to 70° C. The heating device W1 in FIG. 4 is a heat exchanger W1 which extracts the heat from the heated fuel emerging from the fuel return 5 of the injection pump 3, and uses said heat for heating the vegetable oil or vegetable fat. In contrast, the first heating device W1 in FIG. 5 is an electrically operated heating device W1 or a heat exchanger which extracts heat from the diesel engine, in particular from the cooling water of the diesel engine, and uses said heat for heating the vegetable oil or vegetable fat.

The fuel outlet 8 of the third tank T3 is also connected to the mixing valve V6, specifically to the mixture input V63 thereof. The eighth valve V8 is additionally connected to the mixing valve, specifically to the diesel input V61 thereof, wherein diesel fuel can be supplied to the mixing valve V6 in the position V82 of the eighth valve V8. The eighth valve V8 is additionally connected to the fuel inflow 4 of the injection pump 3; here, diesel fuel can flow in the position V81.

The output V64 of the mixing valve V6, in the example as per FIG. 4 and in the example as per FIG. 5, is likewise connected to the fuel inflow 4 of the injection pump 3. A second heating device W2 is integrated in said connection. Said second heating device W2 again has the task of heating the fuel before it enters the injection pump 3, preferably to approximately 60° C. to 70° C.

Here, the second heating device W2 in FIG. 4 is a heat exchanger W2 which, like the heat exchanger W1, extracts the heat from the heated fuel emerging from the fuel return 5 of the injection pump 3, and in this case uses said heat for heating the fuel before it enters the injection pump 3. In contrast, the second heating device W2 in FIG. 5 is an electrically operated heating device W2 or a heat exchanger which extracts heat from the diesel engine, in particular from the cooling water of the diesel engine, and uses said heat for heating the fuel before it enters the injection pump 3.

The mixing valve V6 therefore has three inputs V61, V62, V63 and one output V64, with it being possible for the inputs V61, V62, V63 to be connected to the output in various combinations depending on the position of the mixing valve V6, as is explained below.

In a mixing position of the mixing valve V6, both the diesel input V61 and the vegetable oil and/or fat input V62 are flow-connected to the output V64, and the mixture input V63 is closed. This means that, in the mixing position, diesel fuel from the first T1 and vegetable oil and/or fat from the second tank T2 are mixed in the mixing valve V6 and pass via the output V64 to the injection pump 3. Here, the desired mixing ratio can be set at the mixing valve or is predefined by the mixing valve, for example by means of the opening cross section at the inputs V61, V62. A preferred mixing ratio of the mixture generated in the mixing valve V6 is also 18% diesel fuel and 82% vegetable oil and/or fat here.

In a mixture position of the mixing valve V6, the mixture input V63 is flow-connected to the output V64, and the diesel input V61 and the vegetable oil and/or fat input V62 are closed. This means that, in the mixture position, only fuel mixture from the third tank T3 passes via the mixing valve V6 to the injection pump 3.

The mixing valve V6 can again be one of the known, commercially available mixing valves already mentioned in the preceding examples, which mixing valves can be moved into the respective positions by means of corresponding control.

In contrast to the example as per FIG. 2, in FIG. 4 and FIG. 5, the eighth valve is connected upstream of the mixing valve V6. If the injection pump 3 is to be supplied only with diesel fuel from the first tank Ti, the eighth valve V8 is in the position V81, that is to say the pure fuel passes directly to the injection pump 3 without being diverted via the mixing valve V6 and the second heating device W2. The mixing valve is made superfluous in this case, and a diesel position as in the example as per FIG. 2 can be dispensed with. Heating of the pure diesel fuel is not necessary, as already explained.

As already discussed, in FIG. 4, the fuel return 5 of the injection pump 3 is connected by means of the heat exchanger W2 and the heat exchanger W1 to a seventh valve V7, in particular a 3/2 directional control valve. In FIG. 4, the heating devices W1 and W2 are therefore embodied as heat exchangers which utilize the already-existing high return temperature of the fuel after it leaves the injection pump 3. This makes it possible to dispense with expensive electric fuel heaters which load the battery and the alternator of the vehicle or boot. An alternative connection to the cooling water system of the engine can also be dispensed with. A further alternative to this would be heat exchangers which utilize the waste heat of the engine for heating the fuel, for example by means of the engine cooling water being conducted through the heat exchanger. The solution proposed in claim 4 is simple to implement by means of commercially available plate-type heat exchangers, requires no servicing and does not load the battery and/or the alternator of the vehicle or boat.

In the example as per FIG. 5, the fuel return 5 of the injection pump 3 is connected directly to the seventh valve V7, again in particular a 3/2 directional control valve. Conducting the fuel via the heating devices W1 and W2 is dispensed with. Accordingly, in FIG. 5, the heating devices W1 and W2 are electrically operated heating devices or heat exchangers which are connected to the cooling system of the diesel engine.

FIG. 4 and FIG. 5 also show that the seventh valve V7 is also connected to the fuel inlet 10 of the first tank T1 and to the fuel inlet 11 of the third tank T3, wherein in a first position V71 of the seventh valve V7, the fuel is fed to the first tank T1, and in a second position V72, the fuel is fed to the third tank T3.

It is also the case in the exemplary embodiments as per FIG. 4 and FIG. 5 that the control unit regulates four different states of the fuel line system 9. Said four states are described below (they apply equally to FIG. 4 and FIG. 5):

First state:

Eighth valve V8: first position V81

Mixing valve V6: V61 in any position; V62, V63 closed

Seventh valve V7: first position V71

In the first state of the fuel line system (or first operating state of the fuel supply device), only diesel fuel from the first tank T1 can be fed to the fuel inflow 4 of the injection pump 3 and diesel fuel from the fuel return 5 of the injection pump 3 can be fed only to the fuel inlet 10 of the first tank T1.

In detail, in the first state, diesel fuel from the first tank T1 (diesel tank) flows via the eighth valve V8, which is switched into the first position V81, to the fuel inflow 4 of the injection pump 3. The excess fuel flows from the fuel return 5 of the injection pump 3 via the valve V7, which is switched into the first position V71, back into the first tank T1 (diesel tank). Here, in the example as per FIG. 4, the warm returned fuel dissipates heat into the heat exchangers W1, W2, while this is not the case in the example as per FIG. 5.

Second state:

Eighth valve V8: second position V82

Mixing valve V6: mixing position (V61, V62 open; V63 closed)

Seventh valve V7: second position V72

In the second state of the fuel line system (or second operating state of the fuel supply device), diesel fuel from the first tank T1 (diesel tank) can be fed via the eighth valve V8, which is switched into the second position V82, and vegetable oil and/or fat from the second tank T2 (vegetable oil and/or fat tank) can be fed via the first heating device W1 and the filter F, to the mixing valve V6, which is in its mixing position, so that a fuel mixture in the set mixing ratio emerges at the output V64 of said mixing valve V6. The generated mixture can then be fed from there via the electric heating device W2 to the injection pump 3. The mixture can finally be fed from the fuel return 5 of the injection pump 3, via the valve V7, which is switched into the position V72, only to the fuel inlet 11 of the third tank T3.

In detail, in the second state, diesel fuel from the first tank T1 flows via the eighth valve V8 to the diesel input V61 of the mixing valve V6. At the same time, vegetable oil or vegetable fat from the second tank T2 flows through the heat exchanger W1, in which the fuel is heated to approximately 60° C. to 70° C., to the filter F.

The heating upstream of the filter F is important, since the viscidity of the vegetable oil or vegetable fat at low temperatures can hinder or block the throughflow through the filter. Here, it is advantageous if the heat exchanger W1 and filter F form a structural unit, for example are screwed to one another. In this case, the filter itself is advantageously also heated by the heat exchanger, and its functionality is thereby improved.

From the filter F, the now-filtered fuel flows to the vegetable oil or fat input V62 of the mixing valve V6.

The mixing valve V6 produces a fuel mixture from the diesel fuel and the vegetable oil or vegetable fat, specifically a fuel mixture with a predefined or predefinable percentage mixing ratio of the two fuels. Here, the mixing valve V6 can be designed such that the predefined or predefinable mixing ratio is adjustable (also: variable).

The generated mixture is conducted onward from the output V64 of the mixing valve V6 to the heat exchanger W2, is heated there to approximately 60° C. to 70° C. and is fed onward to the fuel inflow 4 of the injection pump 3. The excess fuel (the mixture) flows from the fuel return 5 of the injection pump 3 via the valve V7, which is switched into the second position V72, into the third tank T3 (mixture tank) and fills the latter. Here, in the variant as per FIG. 4, the warm fuel dissipates heat into the heat exchangers W1, W2, whereas this is not the case in the example as per FIG. 5.

The task of the third tank T3 (mixture tank) is again that of initially storing the excess fuel mixture and later (third state, see below) providing said excess fuel mixture to the diesel engine once again.

The third tank T3 (mixture tank) is fitted with a float switch (not illustrated) for filling level checking (also: fuel volume checking).

Third state:

Eighth valve: second position V82

Mixing valve V6: mixture position (V61, V62 closed; V63 open)

Seventh valve V7: second position V72

In the third state of the fuel line system (or third operating state of the fuel supply device), only the mixture of diesel fuel and vegetable oil and/or fat from the third tank T3 can be fed to the fuel inflow 4 of the injection pump 3 and the excess mixture from the fuel return 5 of the injection pump 3 can be fed only to the fuel inlet 11 of the third tank T3.

In detail, in the third state, the mixture from the third tank T3 flows to the mixture input V63 of the mixing valve V6, which is switched into the mixture position. The mixture passes onward via the output V64 of the mixing valve V6 to the heat exchanger W2, is heated there to approximately 60° C. to 70° C. and is fed onward to the fuel inflow 4 of the injection pump 3. The excess fuel (the mixture) flows from the fuel return 5 of the injection pump 3 via the valve V7, which is switched into the second position V72, into the third tank T3 (mixture tank), and in the process—only in the variant as per FIG. 4 but not in the variant as per FIG. 5—dissipates heat into the heat exchangers W1, W2.

Fourth state:

Eighth valve V8: first position V81

Mixing valve V6: V61 in any position; V62, V63 closed

Seventh valve V7: second position V72

In the fourth state of the fuel line system (or fourth operating state of the fuel supply device), only diesel fuel from the first tank T1 can be fed to the fuel inflow 4 of the injection pump 3 and the excess diesel fuel and/or remaining mixture residues from the fuel return 5 of the injection pump 3 can be fed only to the fuel inlet 11 of the third tank T3. There is always a sufficient residual volume, which can still be filled, available in the third tank T3 for this purpose.

In detail, in the fourth state, diesel fuel from the first tank T1 (diesel tank) flows via the eighth valve V8, which is switched into the first position V81, to the fuel inflow 4 of the injection pump 3. The excess fuel (diesel fuel and/or remaining mixture) flows from the fuel return 5 of the injection pump 3 via the valve V7, which is switched into the second position V72, into the third tank T3 (mixture tank).

The above-described states of the embodiment variants as per FIG. 4 and FIG. 5 are controlled in succession analogously to the above-described exemplary embodiments, such that reference can be made to the corresponding explanations.

Again, the valves V7 and V8 are for example commercially available solenoid valves. The control of the valves V7, V8 can take place electrically and/or electronically and/or mechanically.

The setting of the respective operating state of the fuel supply device or of the respective state of the fuel line system takes place by means of corresponding adjustment of the valves V6, V7 and V8, for example by means of the control unit. The setting of an operating state or the switching between the operating states again takes place as a function of the ignition key position (switching position of the ignition switch, on-off switch) and/or the temperature of the diesel engine (by means of a conventional thermal sensor) and/or the fuel filling of the third tank T3 (mixture tank).

Overall, it is to be noted with regard to all the exemplary embodiments that the transition between the individual operating states of the fuel supply device or the states of the fuel line system need not take place abruptly, but rather can also take place slowly, which is even preferable. This is permitted in particular by means of the mixing valve V6 in the embodiment variants as per FIG. 2, FIG. 3, FIG. 4 and FIG. 5.

A slow transition has the advantage that, in this way, pressure compensation between the different lines is possible without problems, whereas in the case of abrupt state changes, equally abrupt pressure compensation can result in problems, for example in the operation of the injection pump, or even damage.

It should also be noted that the first tank T1, second tank T2 and third tank T3 can of course also be realized within one overall tank, for example by means of corresponding partitioning of said overall tank and by providing the required inlets and outlets in the respective sections of the overall tank.

The exemplary embodiment as per FIG. 1 is optimized in particular for boat engines, and the exemplary embodiments as per FIG. 2 and FIG. 3 and also FIG. 4 and FIG. 5 are optimized in particular for motor vehicle engines.

### LIST OF REFERENCE SYMBOLS

1 Fuel supply device

2 Diesel engine

3 Injection pump

4 Fuel inflow of the injection pump 3

5 Fuel return of the injection pump 3

6 Fuel outlet of the first tank T1

7 Fuel outlet of the second tank T2

8 Fuel outlet of the third tank T3

9 Fuel line system

10 Fuel inlet of the first tank T1

11 Fuel inlet of the third tank T3

T1 First tank for diesel fuel

T2 Second tank for vegetable oil and/or vegetable fat

T3 Third tank for fuel mixture of diesel and vegetable oil and/or fat

F Filter

L Fuel lines

V1 First valve

V11 First position of the first valve V1

V12 Second position of the first valve V1

V2 Second valve

V21 Closed position of the second valve V2

V22 Open position of the second valve V2

V3 Third valve

V31 First position of the third valve V3

V32 Second position of the third valve V3

V4 Fourth valve

V41 First position of the fourth valve V4

V42 Second position of the fourth valve V4

V5 Mixing valve

V6 Mixing valve

V61 Diesel input (also: inlet, inflow)

V62 Vegetable oil or fat input (also: inlet, inflow)

V63 Mixture input (also: inlet, inflow)

V64 Output (also: outlet, outflow), fuel output

V7 Seventh valve

V71 First position of the seventh valve V7

V72 Second position of the seventh valve V7

V8 Eighth valve

V81 First position of the eighth valve V8

V82 Second position of the eighth valve V8

W1,W2,W3 (First, second, third) heating device, heat exchanger.

1-33. (canceled)

34. A fuel supply device for a diesel engine having at least one injection pump which supplies an injection nozzle with fuel and which has a fuel inflow and a fuel return, comprising:
a) at least one first tank for diesel fuel;
b) at least one second tank for vegetable oil and/or vegetable fat, in particular used vegetable oil and/or fat;
c) at least one third tank for holding a mixture of the diesel fuel and the vegetable oil and/or fat;
d) wherein each of the at least three tanks has at least one fuel outlet;
e) a fuel line system which comprises fuel lines and fuel valves;
e1) which fuel line system connects the fuel outlets of all the tanks to the fuel inflow of the injection pump; and
e2) which fuel line system connects the fuel return of the injection pump to a fuel inlet of the first tank and to a fuel inlet of the third tank; and
f) a control unit for controlling the fuel flow through the fuel line system;
g) wherein in a first state of the fuel line system, only diesel fuel from the first tank can be fed to the fuel inflow of the injection pump and diesel fuel from the fuel return of the injection pump can be fed only to the fuel inlet of the first tank;
h) wherein in a second state of the fuel line system, diesel fuel from the first tank and vegetable oil and/or fat from the second tank can be fed, with preceding mixing in the fuel line system, to the fuel inflow of the injection pump and the mixture from the fuel return of the injection pump can be fed only to the fuel inlet of the third tank; and
i) wherein in a third state of the fuel line system, only the mixture of diesel fuel and vegetable oil and/or fat from the third tank can be fed to the fuel inflow of the injection pump and the mixture from the fuel return of the injection pump can be fed only to the fuel inlet of the third tank.

35. The fuel supply device as claimed in claim 34, wherein
in a fourth state of the fuel line system, only diesel fuel from the first tank can be fed to the fuel inflow of the injection pump and diesel fuel and/or remaining mixture residues from the fuel return of the injection pump can be fed only to the fuel inlet of the third tank.

36. The fuel supply device as claimed in claim 34, wherein
the fuel line system comprises at least one mixing valve for providing a mixture of diesel fuel from the first tank and vegetable oil and/or fat from the second tank.

37. The fuel supply device as claimed in claim 36, wherein:
a) the mixture provided by the mixing valve has a mixing ratio in the range from 7% diesel and 93% vegetable oil and/or fat to 93% diesel and 7% vegetable oil and/or fat, in particular a mixing ratio in the range from 15% diesel and 85% vegetable oil and/or fat to 20% diesel and 80% vegetable oil and/or fat, preferably of approximately 18% diesel and 82% vegetable oil and/or fat; and/or
b) the mixing valve is adjustable, in particularly continuously adjustable, in order to regulate and/or set the mixing ratio; and/or
c) the mixing valve is mechanically and/or electrically adjustable.

38. The fuel supply device as claimed in claim 34, wherein
at least one heating device for heating the fuel is integrated into the fuel line system.

39. The fuel supply device as claimed in claim 38, wherein:
a) at least one first heating device is provided for heating the vegetable oil and/or fat which is fed from the second tank after it passes out of the second tank, and/or at least one second heating device is provided for heating the fuel upstream of the fuel inlet of the injection pump, and/or at least one third heating device is provided for heating the vegetable oil and/or fat in the second tank; and/or
b) one or more heating devices are electrically operable heating devices; and/or
c) one or more heating devices are heat exchangers which transfer heat from the fuel returning from the injection pump to the fuel flowing to the injection pump.

40. The fuel supply device as claimed in claim 34, wherein:
a) at least one filter for cleaning the vegetable oil and/or fat and/or the generated mixture is integrated into the fuel line system; and/or
b) a sensor for measuring the filling level of the third tank, in particular a float sensor and/or a float switch, is provided in the third tank.

41. A fuel supply device for a diesel engine having at least one injection pump which supplies an injection nozzle with fuel and which has a fuel inflow and a fuel return, comprising:
a) at least one first tank for diesel fuel;
b) at least one second tank for vegetable oil and/or vegetable fat, in particular used vegetable oil and/or fat;
c) at least one third tank for holding a mixture of the diesel fuel and the vegetable oil and/or fat;
d) wherein each of the at least three tanks has at least one fuel outlet;
e) a fuel line system, which comprises fuel lines and fuel valves, between the tanks and the injection pump;
f) wherein the fuel outlet of the first tank is connected to a first valve, in particular a 3/2 directional control valve;
g) wherein the fuel outlet of the second tank is connected to a second valve, in particular a 2/2 directional control valve;
h) wherein a fuel inlet of the first tank and a fuel inlet of the third tank are connected to a third valve, in particular a 3/2 directional control valve;
i) wherein the first valve is connected to a fourth valve, in particular a 3/2 directional control valve;
j) wherein the first valve and second valve are connected to a mixing valve,
k) wherein the mixing valve is connected to the fourth valve;
l) wherein the fuel outlet of the third tank is connected to the fourth valve;
m) wherein the fourth valve is connected to the fuel inflow of the injection pump;
n) wherein the fuel return of the injection pump is connected to the third valve; and
o) a control unit for controlling the fuel flow through the fuel line system;
p) wherein in a first state of the fuel line system, the first valve is switched into a first position, the second valve is switched into a closed position, the third valve is switched into a first position and the fourth valve is switched into a first position, wherein only diesel fuel from the first tank can be fed to the fuel inflow of the injection pump and diesel fuel from the fuel return of the injection pump can be fed only to the fuel inlet of the first tank;
q) wherein in a second state of the fuel line system, the first valve is switched into a second position, the second valve is switched into an open position, the third valve is switched into a second position and the fourth valve is switched into a first position, wherein diesel fuel from the first tank and vegetable oil and/or fat from the second tank can be fed to the mixing valve and the mixture from the mixing valve can be fed to the fuel inflow of the injection pump and the mixture from the fuel return of the injection pump can be fed only to the fuel inlet of the third tank; and
r) wherein in a third state of the fuel line system, the first valve is switched into a first position or second position, the second valve is switched into a closed position, the third valve is switched into a second position and the fourth valve is switched into a second position, wherein only the mixture of diesel fuel and vegetable oil and/or fat from the third tank can be fed to the fuel inflow of the injection pump and the mixture from the fuel return of the injection pump can be fed only to the fuel inlet of the third tank.

42. The fuel supply device as claimed in claim 41, wherein:
a) in a fourth state of the fuel line system, the first valve is switched into a first position, the second valve is switched into a closed position, the third valve is switched into a second position and the fourth valve is switched into a first position, wherein only diesel fuel from the first tank can be fed to the fuel inflow of the injection pump and diesel fuel and/or remaining mixture residues from the fuel return of the injection pump can be fed only to the fuel inlet of the third tank; and/or
b) at least one first heating device for heating the fuel, in particular an electrically operable heating device, is integrated into the connection between the second tank and the second valve and/or into the connection between the second valve and the mixing valve; and/or
c) at least one filter is integrated into the connection between the second tank and the second valve and/or into the connection between the second valve and the mixing valve; and/or
d) at least one second heating device for heating the fuel, in particular an electrically operable heating device, is integrated into the connection between the fourth valve and the fuel inflow of the injection pump.

43. A fuel supply device for a diesel engine having at least one injection pump which supplies an injection nozzle with fuel and which has a fuel inflow and a fuel return, comprising:
a) at least one first tank for diesel fuel;
b) at least one second tank for vegetable oil and/or vegetable fat, in particular used vegetable oil and/or fat;
c) at least one third tank for holding a mixture of the diesel fuel and the vegetable oil and/or fat;
d) wherein each of the at least three tanks has at least one fuel outlet;
e) a fuel line system, which comprises fuel lines and fuel valves, between the tanks and the injection pump;
f) a mixing valve having a diesel input and a vegetable oil and/or fat input and a mixture input and a fuel output;
g) wherein in a diesel position of the mixing valve, only the diesel input is flow-connected to the fuel output;
h) wherein in a mixing position of the mixing valve, the diesel input and the vegetable oil and/or fat input but not the mixture input are flow-connected to the fuel output;
i) wherein in a mixture position of the mixing valve, only the mixture input is flow-connected to the fuel outlet;
j) wherein the fuel outlet of the first tank is connected to the diesel input of the mixing valve;
k) wherein the fuel outlet of the second tank is connected to the vegetable oil and/or fat input of the mixing valve;
l) wherein a fuel inlet of the first tank and a fuel inlet of the third tank are connected to a seventh valve, in particular a 3/2 directional control valve;
m) wherein the mixing valve is connected to the fuel inflow of the injection pump;
n) wherein the fuel return of the injection pump is connected to the seventh valve; and
o) a control unit for controlling the fuel flow through the fuel line system;
p) wherein in a first state of the fuel line system, the mixing valve is switched into the diesel position and the seventh valve is switched into a first position, wherein only diesel fuel from the first tank can be fed to the fuel inflow of the injection pump and diesel fuel from the fuel return of the injection pump can be fed only to the fuel inlet of the first tank;
q) wherein in a second state of the fuel line system, the mixing valve is switched into the mixing position and the seventh valve is switched into a second position, wherein diesel fuel from the first tank and vegetable oil and/or fat from the second tank can be fed to the mixing valve and the mixture from the mixing valve can be fed to the fuel inflow of the injection pump and the mixture from the fuel return of the injection pump can be fed only to the fuel inlet of the third tank; and
r) wherein in a third state of the fuel line system, the mixing valve is switched into the mixture position and the seventh valve is switched into the second position, wherein only the mixture of diesel fuel and vegetable oil and/or fat from the third tank can be fed to the fuel inflow of the injection pump and the mixture from the fuel return of the injection pump can be fed only to the fuel inlet of the third tank.

44. The fuel supply device as claimed in claim 43, wherein:
a) in a fourth state of the fuel line system, the mixing valve is switched into the diesel position and the seventh valve is switched into the second position, wherein only diesel fuel from the first tank can be fed to the fuel inflow of the injection pump and diesel fuel and/or remaining mixture residues from the fuel return of the injection pump can be fed only to the fuel inlet of the third tank; and/or
b) one or more heating devices for heating the fuel, in particular electrically operable heating devices and/or heat exchangers which transfer heat from the fuel returning from the injection pump to the fuel flowing to the injection pump, are integrated into the second tank and/or into the connection between the second tank and the mixing valve and/or into the connection between the mixing valve and the injection pump; and/or
c) at least one filter is integrated into the connection between the second tank and the mixing valve.

45. A fuel supply device for a diesel engine having at least one injection pump which supplies an injection nozzle with fuel and which has a fuel inflow and a fuel return, comprising:
a) at least one first tank for diesel fuel;
b) at least one second tank for vegetable oil and/or vegetable fat, in particular used vegetable oil and/or fat;
c) at least one third tank for holding a mixture of the diesel fuel and the vegetable oil and/or fat;
d) wherein each of the at least three tanks has at least one fuel outlet;
e) a fuel line system, which comprises fuel lines and fuel valves, between the tanks and the injection pump;
f) a mixing valve having a diesel input and a vegetable oil and/or fat input and a mixture input and a fuel output;
g) wherein the fuel outlet of the first tank is connected to an eighth valve, in particular a 3/2 directional control valve;
h) wherein the eighth valve is connected to the diesel input of the mixing valve and to the fuel inflow of the injection pump;
i) wherein in a mixing position of the mixing valve, the diesel input and the vegetable oil and/or fat input but not the mixture input are flow-connected to the fuel output;
j) wherein in a mixture position of the mixing valve, only the mixture input is flow-connected to the fuel outlet;
k) wherein the fuel outlet of the second tank is connected to the vegetable oil and/or fat input of the mixing valve;
l) wherein a fuel inlet of the first tank and a fuel inlet of the third tank are connected to a seventh valve, in particular a 3/2 directional control valve;
m) wherein the mixing valve is connected to the fuel inflow of the injection pump;
n) wherein the fuel return of the injection pump is connected to the seventh valve; and
o) a control unit for controlling the fuel flow through the fuel line system;
p) wherein in a first state of the fuel line system, the eighth valve is switched into a first position and the vegetable oil and/or fat input and the mixture input of the mixing valve are switched into a closed position and the seventh valve is switched into a first position, wherein only diesel fuel from the first tank can be fed to the fuel inflow of the injection pump and diesel fuel from the fuel return of the injection pump can be fed only to the fuel inlet of the first tank;
q) wherein in a second state of the fuel line system, the eighth valve is switched into a second position and the mixing valve is switched into the mixing position and the seventh valve is switched into a second position, wherein diesel fuel from the first tank and vegetable oil and/or fat from the second tank can be fed to the mixing valve and the mixture from the mixing valve can be fed to the fuel inflow of the injection pump and the mixture from the fuel return of the injection pump can be fed only to the fuel inlet of the third tank; and
r) wherein in a third state of the fuel line system, the eighth valve is switched into a second position and the mixing valve is switched into the mixture position and the seventh valve is switched into the second position, wherein only the mixture of diesel fuel and vegetable oil and/or fat from the third tank can be fed to the fuel inflow of the injection pump and the mixture from the fuel return of the injection pump can be fed only to the fuel inlet of the third tank.

46. The fuel supply device as claimed in claim 45, wherein:
a) in a fourth state of the fuel line system, the eighth valve is switched into a first position and the vegetable oil and/or fat input and the mixture input of the mixing valve are switched into a closed position and the seventh valve is switched into the second position, wherein only diesel fuel from the first tank can be fed to the fuel inflow of the injection pump and diesel fuel and/or remaining mixture residues from the fuel return of the injection pump can be fed only to the fuel inlet of the third tank, and/or
b) one or more heating devices for heating the fuel, in particular electrically operable heating devices and/or heat exchangers which transfer heat from the fuel returning from the injection pump to the fuel flowing to the injection pump, are integrated into the second tank and/or into the connection between the second tank and the mixing valve and/or into the connection between the mixing valve and the injection pump, and/or
c) at least one filter is integrated into the connection between the second tank and the mixing valve.

47. The fuel supply device as claimed in claim 34, designed and intended to be retrofitted to a diesel engine.

48. A diesel engine having at least one injection pump, comprising a fuel supply device (1) as claimed in claim 1.

49. A method for operating a fuel supply device for a diesel engine having at least one injection pump:
a) wherein the fuel supply device comprises:
a1) at least one first tank for diesel fuel;
a2) at least one second tank for vegetable oil and/or vegetable fat, in particular used vegetable oil and/or fat;
a3) at least one third tank for holding a mixture of the diesel fuel and the vegetable oil and/or fat;
a4) a fuel line system, which comprises fuel lines and fuel valves, between the tanks and the injection pump;
a5) a control unit for controlling the fuel flow through the fuel line system;
wherein the method comprises:
b) when the diesel engine is started until the operating temperature of the diesel engine, in particular approximately 80° C. to approximately 95° C., preferably approximately 87° C. to approximately 90° C., is reached, in a first state of the fuel supply device, diesel fuel from the first tank is fed to the injection pump and diesel fuel from the injection pump is fed only to the first tank;
c) after the operating temperature of the diesel engine is reached, in a second operating state of the fuel supply device, diesel fuel from the first tank and vegetable oil and/or fat from a second tank are mixed, in particular in a mixing valve, and subsequently only the mixture is fed to the injection pump and the mixture from the injection pump is fed to the third tank, specifically until a predefined upper filling level in the third tank is reached or exceeded;
d) after the predefined upper filling level in the third tank is reached or exceeded until a predefined lower filling level in the third tank is reached or undershot, in a third operating state of the fuel supply device, only the mixture of diesel fuel and vegetable oil and/or fat from the third tank is fed to the injection pump and the mixture from the injection pump is fed only to the third tank;
e) after the predefined lower filling level is reached or undershot again until the predefined upper filling level is reached or exceeded, in the second operating state again, diesel fuel from the first tank and vegetable oil and/or fat from a second tank are mixed, in particular in a mixing valve, and subsequently the mixture is fed to the injection pump and the mixture from the injection pump is fed only to the third tank; and
f) the fuel supply device is subsequently operated further in alternation between step d) and step e), specifically until a shut-down phase of the diesel engine is initiated or until the diesel engine is shut down.

50. The method as claimed in claim 49,
characterized in that
when a shut-down phase of the diesel engine is initiated, in a fourth operating state of the fuel supply device, only diesel fuel from the first tank is fed to the injection pump and diesel fuel and/or remaining mixture residues from the injection pump fed only to the third tank specifically for a time which is predefined, in particular as a function of the line volume which is to be flushed.

51. The method as claimed in claim 50,
characterized in that;
after the expiry of the predefined time, the diesel engine is finally shut down or, until the final shutdown of the diesel engine, in the first operating state of the fuel supply device, diesel fuel from the first tank is fed to the injection pump and diesel fuel from the injection pump is fed only to the first tank.

52. The method as claimed in claim 49,
wherein:
a) the shutdown phase of the diesel engine is initiated automatically, in particular when a shutdown device is actuated, or manually; and/or
b) the filling level in the third tank is determined by means of a sensor, in particular a float sensor and/or a float switch; and/or
c) the vegetable oil and/or fat is heated in the second tank and/or after it passes out of the second tank, and/or the mixture is heated before it enters the injection pump, in particular to approximately 60° C. to 70° C., in particular by means of one or more heating devices, preferably electrically operated heating devices and/or heat exchangers which transfer heat from the fuel returning from the injection pump to the fuel flowing to the injection pump; and/or
d) in the second operating state of the fuel supply device, during the mixing of the diesel fuel and vegetable oil and/or fat, in particular in a mixing valve, a mixture is generated with a mixing ratio in the range from 7% diesel and 93% vegetable oil and/or fat to 93% diesel and 7% vegetable oil and/or fat, in particular a mixing ratio in the range from 15% diesel and 85% vegetable oil and/or fat to 20% diesel and 80% vegetable oil and/or fat, preferably of approximately 18% diesel and 82% vegetable oil and/or fat.
